(19) United States
(12) Patent Application Publication
(10) Pub. No.: US 2024/0346831 A1
(43) Pub. Date: Oct. 17, 2024

(54) INVESTIGATION AREA DETERMINATION DEVICE, INVESTIGATION AREA DETERMINATION METHOD, AND RECORDING MEDIUM

(71) Applicant: NEC Corporation, Minato- ku, Tokyo (JP)

(72) Inventors: Chisato SUGAWARA, Tokyo (JP); Yosuke KIMURA, Tokyo (JP); Nana JUMONJI, Tokyo (JP); Takakazu ISHII, Tokyo (JP); Daisuke HASHIZUME, Tokyo (JP); Hiromichi HIRATA, Tokyo (JP); Shouhei OHNO, Tokyo (JP)

(73) Assignee: NEC Corporation, Minato- ku, Tokyo (JP)

(21) Appl. No.: 18/293,407

(22) PCT Filed: Aug. 13, 2021
(86) PCT No.: PCT/JP2021/029796

§ 371 Date: Jan. 30, 2024

(51) Int. Cl. G06V 20/58; G01S 13/90; G06Q 50/26

(52) U.S. Cl. CPC G06V 20/58; G01S 13/9021; G06Q 50/265

(57) ABSTRACT

In order to determine an appropriate investigation area, this investigation area determination device includes: a candidate area extraction means for extracting a candidate area for an investigation of the state of a disaster, by using sensor information that has been acquired by a sensor information acquisition device; a ground surface information acquisition means for acquiring a ground surface change in the candidate area, the ground surface change being the results of analysis using the results of measurement carried out by a ground surface measurement device; and an investigation area determination means for determining, by using the ground surface change, an area for the investigation of the state of a disaster in the candidate area.

### TECHNICAL FIELD

The present invention relates to determination of an investigation area, and in particular to determination of an investigation area for investigation of a disaster situation.

### BACKGROUND ART

Various technologies have been proposed to support investigation of disaster situations. For example, PTLs 1 and 2 describe techniques for supporting investigation of disaster situations. The disaster countermeasure assistance method described in PTL 1 grasps a disaster situation using a synthetic aperture radar mounted on an artificial satellite. When determining that a disaster has occurred, the vehicle control device described in PTL 2 captures an image using an imaging unit mounted on the vehicle, and accumulates the image and position information in association with each other.

### CITATION LIST

### Patent Literature

PTL 1: WO 2008/016153 A1
PTL 2: JP 2020-127091 A

### SUMMARY OF INVENTION

### Technical Problem

Since the technique described in PTL I uses a synthetic aperture radar, there is a case where a detailed situation of a disaster cannot be grasped. The technique described in PTL 2 is a technique for acquiring an image of a position of a vehicle at the time of occurrence of a disaster, and thus, there is a case where an image that can be used for investigation of a disaster situation cannot be acquired. Therefore, it is desired to determine an appropriate disaster situation investigation area.

An object of the present invention is to provide an investigation area determination device or the like that determines an appropriate investigation area.

### Solution to Problem

An investigation area determination device according to an aspect of the present invention includes a candidate area extraction means configured to extract a candidate area for investigation of a disaster situation using sensor information acquired by a sensor information acquisition device, a ground surface information acquisition means configured to acquire a ground surface change that is a result of an analysis using a measurement result made by a ground surface measurement device in the candidate area, and an investigation area determination means configured to determine an investigation area for investigation of a disaster situation in the candidate area using the ground surface change.

An investigation area determination system according to an aspect of the present invention includes the investigation area determination device described above, the sensor information acquisition device that outputs the sensor information to the investigation area determination device, and the ground surface measurement device that outputs the measurement result to the investigation area determination device, and a display device that acquires the investigation area from the investigation area determination device and displays the investigation area, and.

An investigation area determination method according to an aspect of the present invention includes extracting a candidate area for investigation of a disaster situation using sensor information acquired by a sensor information acquisition device, acquiring a ground surface change that is a result of an analysis using a measurement result made by a ground surface measurement device in the candidate area, and determining an investigation area for investigation of a disaster situation in the candidate area using the ground surface change.

An investigation area determination method according to an aspect of the present invention includes causing an investigation area determination device to execute the method described above, causing the sensor information acquisition device to output the sensor information to the investigation area determination device, causing the ground surface measurement device to output the measurement result to the investigation area determination device, and causing a display device to acquire the investigation area from the investigation area determination device and display the investigation area.

A recording medium according to an embodiment of the present invention records a program for causing a computer to execute the steps of extracting a candidate area for investigation of a disaster situation using sensor information acquired by a sensor information acquisition device, acquiring a ground surface change that is a result of an analysis using a measurement result made by a ground surface measurement device in the candidate area, and determining an investigation area for investigation of a disaster situation in the candidate area using the ground surface change.

### Advantageous Effects of Invention

According to the present invention, it is possible to achieve an effect of determining an appropriate investigation area.

### BRIEF DESCRIPTION OF DRAWINGS

FIG. 1 is a block diagram illustrating an example of a configuration of an investigation area determination system according to the first example embodiment.

FIG. 2 is a conceptual diagram illustrating an example of a configuration of an investigation area determination system according to the first example embodiment.

FIG. 3 is a diagram illustrating an example of a candidate area.

FIG. 4 is a diagram for describing an investigation area and a hazardous area.

FIG. 5 is a flowchart illustrating an example of an operation of the investigation area determination device according to the first example embodiment.

FIG. 6 is a block diagram illustrating an example of a hardware configuration of the investigation area determination device.

FIG. 7 is a block diagram illustrating an example of a configuration of an investigation area determination system according to the second example embodiment.

FIG. 8 is a diagram for describing an investigation area based on a prediction of a disaster range.

FIG. 9 is a flowchart illustrating an example of operation of the investigation area determination device according to the second example embodiment.

FIG. 10 is a block diagram illustrating an example of a configuration of an investigation area determination device according to the third example embodiment.

FIG. 11 is a block diagram illustrating an example of a configuration of an investigation area determination system according to the fourth example embodiment.

### EXAMPLE EMBODIMENT

Next, an example embodiment of the present invention will be described with reference to the drawings. However, each example embodiment of the present invention is not limited to the description of the drawings. Each example embodiment can be appropriately combined.

### <Terms>

The “sensor information acquisition device” is a device that includes a predetermined sensor and acquires sensor information related to a structure and its periphery. For example, the structure may include a road, a bridge, a slope frame, an embankment, a pier, a revetment, or a runway. The sensor information will be described later. The sensor information acquisition device may be a device that is mounted on or towed by a mobile body and moves, or may be a fixed device. For example, the moving device may be a dashboard camera (dashcam). The fixed device may be a fixed camera. For example, the mobile body may include a vehicle, an unmanned aerial vehicle (drone), or a person. The fixed camera used as the sensor information acquisition device is not limited to a camera having a fixed imaging direction, and may be a camera capable of changing at least one of an imaging direction and an imaging position in a certain range.

The “sensor information” is information acquired using a predetermined sensor in order to determine a situation of a structure and a situation around the structure. For example, the sensor may include a camera, a speedometer, an accelerometer, an angle meter, or a distance meter. For example, the acquired information may include an image, a speed, acceleration, an angle, or a distance. For example, the sensor information is an image captured or acceleration measured by a dashcam mounted on a vehicle traveling on a structure such as a road or a bridge. Alternatively, when the sensor is light detection and ranging (LIDAR), the sensor information is distance information. The sensor information may include a plurality of pieces of information. For example, the plurality of pieces of information may be images and accelerations, or a plurality of images such as moving images. However, the sensor information is not limited to the image, the speed, the acceleration, and the distance, and may be any information as long as the information can be used for disaster determination. In other words, the sensor is not limited to a camera, a speedometer, an accelerometer, an angle meter, or a distance meter.

Further, the sensor information may include information related to acquisition of the sensor information. For example, the sensor information may include an acquisition time or an acquisition position as information related to acquisition of the sensor information. Hereinafter, the information related to the acquisition of the sensor information is referred to as “acquisition-related information”. Alternatively, the sensor information may include information related to the sensor information acquisition device or information related to the sensor. For example, the sensor information may include a device name, an attachment position, or an orientation of the sensor information acquisition device as the information related to the sensor information acquisition device, and may include a specification of the sensor as the information related to the sensor. Hereinafter, the information related to the sensor information acquisition device and the information related to the sensor are collectively referred to as “acquisition device information”.

Furthermore, the sensor information may include information related to the mobile body on which the sensor information acquisition device is mounted. For example, the mobile body is a vehicle. Alternatively, for example, the information related to the mobile body is the model number of the vehicle. Hereinafter, the information related to the mobile body is referred to as “mobile body information”. Furthermore, the sensor information may include information related to the operation of the mobile body on which the sensor information acquisition device is mounted. The mobile body is, for example, a vehicle. In the case of the vehicle, the information related to the operation of the mobile body is, for example, information related to an operation such as an accelerator pedal, a brake pedal, a shift lever, a steering wheel, a wiper, a blinker, and opening and closing of a door. Hereinafter, information related to the operation of the mobile body is referred to as “operation information”. Alternatively, the sensor information may include information related to the periphery of the sensor information acquisition device in the acquisition of the sensor information. For example, the information related to the periphery may include weather, temperature, humidity, illuminance, congestion, or sound. Hereinafter, information related to the periphery is referred to as “periphery information”. Alternatively, the sensor information may include information added by the operator of the acquisition work. The information added by the operator is, for example, a comment of the operator. Hereinafter, the information added by the operator is referred to as “additional information”.

Hereinafter, the information included in the sensor information excluding the information acquired by the sensor is collectively referred to as “related information”. For example, the information acquired by the sensor may be an image. The information included in the sensor information may be information including at least one of acquisition-related information, acquisition device information, mobile body information, operation information, periphery information, and additional information. In this manner, the sensor information may include related information in addition to the information acquired by the sensor. For example, the information acquired by the sensor may be an image. However, the related information may be treated as information different from the information acquired by the sensor. For example, one file may store the information acquired by the sensor and the related information as separate information. However, in the following description, it is assumed that the sensor information includes information acquired by the sensor and related information.

A specific example of association between the sensor information acquisition device, the sensor, and the sensor information will be described. For example, in a case where the sensor information acquisition device is a dashcam, the sensor is a camera. The sensor information is, for example, an image. When the sensor information acquisition device is an accelerometer, the sensor is an accelerometer.

The sensor information is acceleration. The sensor information acquisition device may include a plurality of sensors. The plurality of sensors in this case may be a plurality of sensors of the same type or a plurality of types of sensors. For example, the plurality of types of sensors may be cameras, accelerometers, and angle meters. For example, in a case where the sensor information acquisition device is a dashcam, the dashcam may include a camera and an accelerometer and acquire an image and acceleration. In the following description, a dashcam, a camera, and an image are used as examples of the sensor information acquisition device, the sensor, and the sensor information, respectively. A vehicle is used as an example of the mobile body.

A “synthetic aperture radar” is a radar that transmits and receives radio waves while a flying object is moving, and acquires an image equivalent to that in the case of an antenna having a large aperture. Hereinafter, the synthetic aperture array is referred to as an “SAR”. The resolution in radar observation is improved as the antenna is increased. However, the size of an antenna that can be mounted on an artificial satellite or the like is limited. Therefore, the SAR uses an antenna having a small actual aperture length to transmit and receive radio waves while flying, thereby improving the resolution in the traveling direction. That is, SAR artificially “combines” the “apertures” to form a virtually large antenna. The flying object may be any flying object as long as it is a flying object equipped with the SAR. For example, the flying object is an artificial satellite, an aircraft, or an unmanned aerial vehicle (drone).

The SAR outputs an image as a measurement result. Hereinafter, an image as a measurement result made by the SAR is referred to as an “SAR image”. Each example embodiment can analyze a “change in the ground surface” using SAR images. Hereinafter, the “change in the ground surface” may be simply referred to as a “ground surface change”. For example, each example embodiment can analyze the change in height of the ground surface between two times using two SAR images at different times at the same location as the change in the ground surface. Alternatively, each example embodiment may analyze a change in intensity of the ground surface as a change in the ground surface.

In each example embodiment, an any method may be used as a method of analyzing the change in height and the change in intensity. For example, each example embodiment may use a technique such as change extraction, time series interference analysis, or coherent change extraction. Alternatively, each example embodiment may execute machine training using a past SAR image or the like as teacher data, and apply the SAR image to an analysis model generated as a result of execution of the machine training to analyze a change in the ground surface. The analysis of the change in the ground surface is not limited to the analysis of the change in height of the ground surface and the change in intensity of the ground surface, and may include other analysis. For example, the other analyses may include an analysis of factors of the change in the ground surface or an analysis of the magnitude of risk based on the change in the ground surface. As described above, the SAR is a device that measures the ground surface in order to acquire measurement results for analyzing the change in the ground surface. For example, the measurement result may be an SAR image.

However, in each example embodiment, a device that acquires a measurement result for analyzing a change in the ground surface, that is, a device that measures the ground surface is not limited to the SAR. Examples of the device that measures the ground surface include an optical sensor or a laser measuring device mounted on any of an artificial satellite, an aircraft, and an unmanned aerial vehicle (drone). Each example embodiment may analyze the change in the ground surface using measurement results made by a device or system that measures the ground surface as described above. For example, the measurement result may be an optical image. In the following description, the device and the system that measure the ground surface are collectively referred to as “ground surface measurement devices”.

The ground surface measurement device includes a device that analyzes a “change in the ground surface” using a measurement result to output the “change in the ground surface” that is a result of the analysis. That is, the ground surface measurement device may output a measurement result or may output a change in the ground surface as an analysis result. Therefore, in the following description, in order to avoid complication of the description, the above cases will be summarized unless otherwise distinguished, and the device of each example embodiment will be described as acquiring a change in the ground surface that is a result of an analysis using the measurement result made by the ground surface measurement device. In the following description, the SAR and the SAR images are used as examples of the ground surface measurement device and the measurement result.

the SAR includes a device capable of acquiring a measurement result using a plurality of frequencies (multispectra). Hereinafter, a device capable of acquiring a measurement result using multispectra is referred to as a “multispectra measurement device”. When the measurement result using the multispectra is used, not only the change in the ground surface but also the type of the ground surface can be analyzed. Therefore, each example embodiment may analyze the type of the ground surface using the measurement result made by the SAR using multispectra, and use the analyzed type of the ground surface. The type of the ground surface is determined in accordance with the frequency to be used. For example, the type of the ground surface includes at least one of a water surface, mud, garbage, dry soil, grassland, forest, farmland, and snow cover. As described above, the type of the ground surface is one of the results of analysis on the measurement results of the ground surface. Therefore, in the following description, a change in the ground surface including the type of the ground surface is referred to unless a particularly distinguished description is necessary. That is, the change in the ground surface in the following description may include the type of ground surface.

The measurement results of the ground surface measurement device such as the SAR include a wide range to some extent. Therefore, the analysis using a measurement result made by a ground surface measurement device such as the SAR can acquire a wide range of the change in the ground surface to some extent. The SAR measures the ground surface from a certain altitude. Therefore, the ground surface measurement device such as the SAR can measure the ground surface even when a disaster or the like occurs. However, the accuracy of the result of the analysis using the measurement result acquired by the SAR is of an order of meters. It is often desirable that the accuracy of determining the situation of the ground surface is of an order of several centimeters to a dozen centimeters.

On the other hand, the accuracy of the determination using the sensor information acquired from the dashcam is an order of several centimeters to several tens of centimeters. However, the sensor information acquired by the dashcam is information in a narrow range with respect to the SAR measurement result. Therefore, in a case where the sensor information is acquired at all positions in a region to be managed such as a local government, a lot of time and man-hours are required to acquire the sensor information using the dashcam. It is desirable to quickly investigate the disaster situation. Therefore, it is desired to provide an effective investigation area for investigating the disaster situation using the sensor information acquired by the dashcam.

That is, in order to implement investigation of a disaster situation using sensor information, it is desired to provide information about an appropriate investigation area for acquiring sensor information. Therefore, as will be described below, each example embodiment of the present invention provides an appropriate investigation area as a disaster situation investigation using sensor information acquired by a sensor information acquisition device and a change in the ground surface that is a result of an analysis using a measurement result made by a ground surface measurement device.

### First Example Embodiment

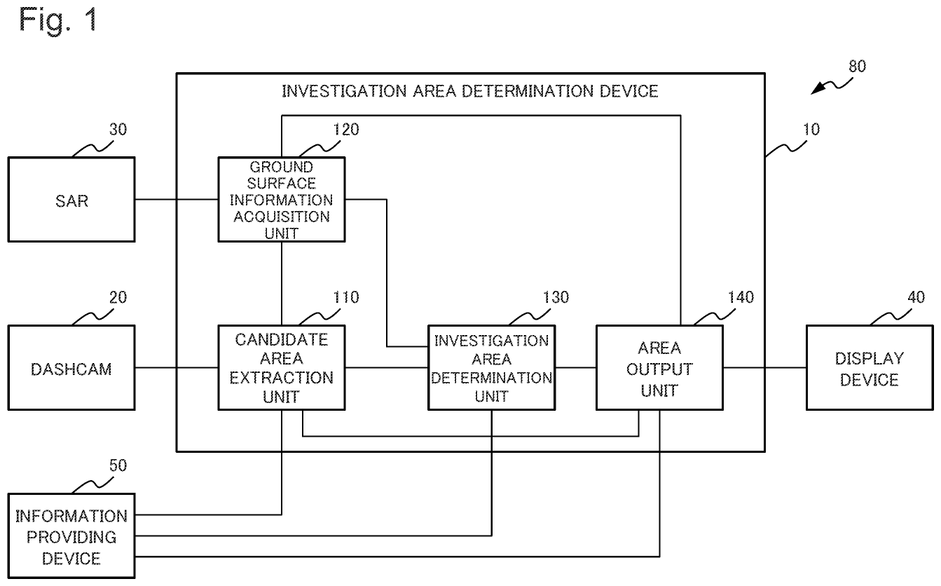

The first example embodiment of the present invention will be described with reference to the drawings. FIG. 1 is a block diagram illustrating an example of a configuration of an investigation area determination system 80 according to the first example embodiment. The investigation area determination system 80 includes an investigation area determination device 10, a dashcam 20, an SAR 30, a display device 40, and an information providing device 50. The number of components in FIG. 1 is an example, and is not limited to the example illustrated in FIG. 1. For example, the investigation area determination system 80 may include a plurality of dashcams 20.

The dashcam 20 outputs the sensor information to the investigation area determination device 10. The dashcam 20 is mounted on a vehicle, for example, and acquires sensor information such as a road on which the vehicle travels. For example, the dashcam 20 acquires an image of a road. Then, the dashcam 20 outputs the acquired sensor information to the investigation area determination device 10. However, the mobile means of the dashcam 20 is not limited to the vehicle. For example, the dashcam 20 may be mounted on a mobile body other than the vehicle. For example, the dashcam 20 may be mounted on an unmanned aerial vehicle (drone). Alternatively, a person or the like may carry the dashcam 20. In the present example embodiment, a device that is fixed at an any place and can acquire and output sensor information, such as a fixed camera, may be included as the dashcam 20.

The investigation area determination system 80 may include a plurality of dashcams 20. For example, the investigation area determination system 80 may include the dashcam 20 mounted on each of a plurality of vehicles, or may include the dashcam 20 mounted on a mobile body and the dashcam 20 fixed at a predetermined position.

The SAR 30 outputs a measurement result or a change in the ground surface to the investigation area determination device 10. For example, the SAR 30 outputs an SAR image that is a measurement result to the investigation area determination device 10. In this case, the investigation area determination device 10 may analyze the “change in the ground surface” using the SAR image acquired from the SAR 30. The SAR 30 may output an SAR image in a preset range, or may output an SAR image in a range requested by the investigation area determination device 10. For example, the preset range may be an imaging range or a measurement range.

Alternatively, the SAR 30 may output, to the investigation area determination device 10, a “change in the ground surface” that is a result of analyzing the SAR image. Also in this case, the SAR 30 may output a change in the ground surface in a preset range, or may output a change in the ground surface in a range requested by the investigation area determination device 10. The preset range is, for example, an analysis range. The SAR 30 may measure the ground surface using multispectra. In this case, the SAR 30 may output a multispectra measurement result or may output a type of the ground surface analyzed using the multispectral measurement result.

The display device 40 displays information output by the investigation area determination device 10. For example, the information output by the investigation area determination device 10 may be the investigation area. The display device 40 may be any device as long as the device displays the information output by the investigation area determination device 10. The installation position of the display device 40 may be any place where it can be installed. Alternatively, the display device 40 may be a portable device such as a cellular phone, a smartphone, or a tablet, instead of a device installed at a predetermined place. For example, the display device 40 may be a display included in a disaster assistance system of a local government. Alternatively, the display device 40 may be a device mounted for a vehicle on which the dashcam 20 is mounted. For example, the device mounted for a vehicle may be a car navigation device. Furthermore, the display device 40 may be a device included in any devices or a device including another device. For example, the display device 40 may be included in the investigation area determination device 10. Alternatively, the display device 40 may be a device including the investigation area determination device 10.

The information providing device 50 provides the information requested by the investigation area determination device 10. The information providing device 50 may be any device as long as the device provides the information requested by the investigation area determination device 10. The user or the like of the investigation area determination device 10 may determine the information to be acquired from the information providing device 50 and the information providing device 50 in consideration of the information necessary for determining the investigation area in the investigation area determination device 10. For example, the information providing device 50 may provide map information such as a road to the investigation area determination device 10. Alternatively, the information providing device 50 may provide the information related to a disaster to the investigation area determination device 10. Hereinafter, the information related to a disaster is referred to as “disaster information”.

The disaster information may be any information as long as the information is related to a target disaster. For example, the disaster information may be information related to information about a disaster range, information about a secondary disaster, and information related to disaster information at the time of a similar disaster in the past and the like. Alternatively, the disaster information may be weather-related information such as a rainfall range, an amount of rainfall, rain cloud information, a wind direction, and a wind volume. For example, the rain cloud information may be a position, a range, and a moving direction of the rain cloud. Alternatively, the disaster information may be information related to an earthquake, such as a seismic source, seismic intensity, and a situation of an aftershock. Alternatively, the disaster information may be information related to a social infrastructure such as a power outage, a water outage, or a supply stop of city gas.

Alternatively, the disaster information may be information related to a map such as a topographical map and a hazard map.

The investigation area determination device 10 outputs an area to be investigated. Hereinafter, an area to be investigated is referred to as an “investigation area”. Therefore, the investigation area determination device 10 acquires the sensor information from the dashcam 20. For example, the investigation area determination device 10 acquires a road image from the dashcam 20. The investigation area determination device 10 may acquire the sensor information from the dashcam 20, or may acquire the sensor information from a device that stores the sensor information acquired by the dashcam 20. However, in the following description, as an example, the investigation area determination device 10 will be described as acquiring the sensor information from the dashcam 20. Then, the investigation area determination device 10 extracts an area to be a candidate for the investigation area using the sensor information. Hereinafter, an area to be a candidate for the investigation area is referred to as a “candidate area”. Then, the investigation area determination device 10 acquires an SAR image in the candidate area from the SAR 30, and analyzes a change in the ground surface in the candidate area using the acquired SAR image. Alternatively, the investigation area determination device 10 acquires, from the SAR 30, a change in the ground surface that is a result of analyzing the SAR image acquired by the SAR 30 in the candidate area. That is, although the subject of the analysis is different, the investigation area determination device 10 acquires a change in the ground surface that is a result of the analysis using the measurement result made by the SAR 30 in the candidate area. The investigation area determination device 10 may acquire the SAR image or the change in the ground surface from the SAR 30, or may acquire the SAR image or the change in the ground surface from a device that stores the SAR image or the change in the ground surface. However, in the following description, as an example, the investigation area determination device 10 will be described as acquiring an SAR image or a change in the ground surface from the SAR 30. Then, the investigation area determination device 10 determines the investigation area for investigation of the disaster situation in the candidate area using the acquired change in the ground surface. Then, the investigation area determination device 10 outputs the determined investigation area.

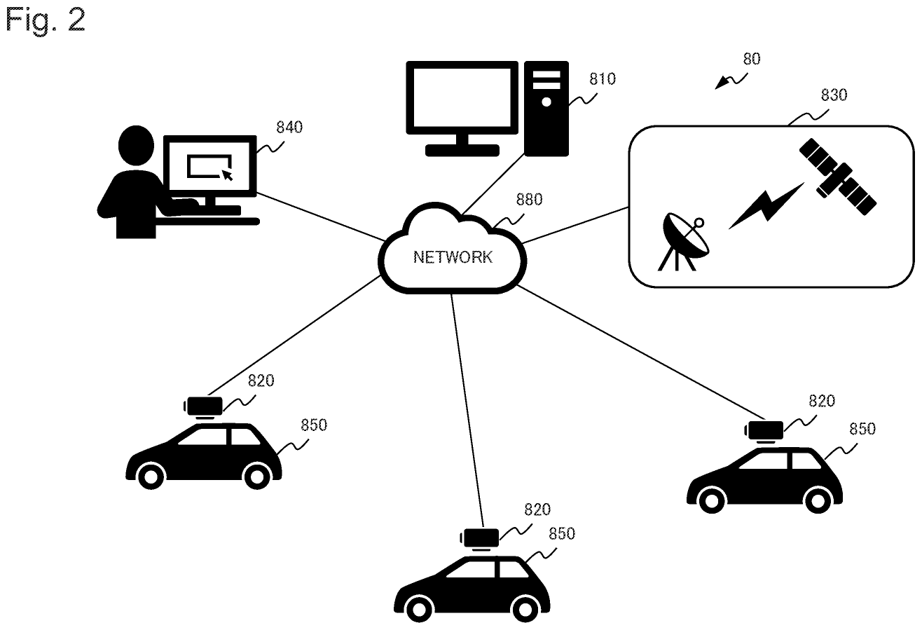

FIG. 2 is a conceptual diagram illustrating an example of a configuration of the investigation area determination system 80 according to the first example embodiment. The investigation area determination system 80 in FIG. 2 includes a computer 810 as an example of the investigation area determination device 10, a dashcam 820 as an example of the dashcam 20, and an SAR system 830 including an artificial satellite and a ground station as an example of the SAR 30. Further, the investigation area determination system 80 in FIG. 2 includes a terminal device 840 as an example of the display device 40. Furthermore, the investigation area determination system 80 in FIG. 2 includes a vehicle 850 as an example of a mobile body that moves with the dashcam 820 mounted thereon.

Furthermore, the investigation area determination system 80 of FIG. 2 includes a network 880 as a communication path for connecting devices and systems. The network 880 is a communication path that connects each device and the system to each other. The network 880 is not particularly limited as long as each device and the system can be connected. For example, the network 880 may be the Internet, a public telephone line, or a combination thereof. In FIG. 2, the information providing device 50 is omitted.

The configuration of the investigation area determination system 80 included in FIG. 2 is an example. The number of components is not limited to the example illustrated in FIG. 2. For example, the investigation area determination system 80 may include one, two, or four or more dashcams 820. Alternatively, at least some of the dashcams 820 may not be mounted on the vehicle 850. For example, the investigation area determination system 80 may include a fixed camera as the dashcam 820. In FIG. 2, the dashcam 820 is displayed outside the vehicle 850 for easy understanding. However, the dashcam 820 may be mounted inside the vehicle 850.

The vehicle 850 on which the dashcam 820 is mounted travels on a structure such as a road or a bridge. The dashcam 820 is mounted on the vehicle 850, acquires sensor information about a road, a bridge, and the like on which the vehicle 850 travels to output the acquired sensor information to the computer 810. For example, the dashcam 820 is mounted on the vehicle 850, acquires an image and acceleration of a road, a bridge, and the like on which the vehicle 850 travels to output the acquired image and acceleration to the computer 810. The computer 810 acquires the sensor information from the dashcam 820 and extracts a candidate area using the acquired sensor information.

Then, the computer 810 acquires the SAR image of the candidate area from the SAR system 830, and analyzes the change in the ground surface using the acquired SAR image. However, the computer 810 may acquire, from the SAR system 830, the change in the ground surface in the candidate area. That is, the computer 810 acquires a change in the ground surface that is a result of an analysis using the SAR image acquired by the SAR system 830 in the candidate area. Then, the computer 810 determines an investigation area in the candidate area using a change in the ground surface. Then, the computer 810 outputs the investigation area to the terminal device 840. The terminal device 840 displays the investigation area acquired from the computer 810.

Specific devices to be the computer 810, the dashcam 820, the SAR system 830, the terminal device 840, and the vehicle 850 included in the investigation area determination system 80 are not particularly limited. As the computer 810, the dashcam 820, the SAR system 830, the terminal device 840, and the vehicle 850, generally available products and systems may be used. Therefore, a detailed description thereof will be omitted.

Next, a configuration of the investigation area determination device 10 will be described with reference to FIG. 1. The investigation area determination device 10 includes a candidate area extraction unit 110, a ground surface information acquisition unit 120, an investigation area determination unit 130, and an area output unit 140.

The candidate area extraction unit 110 extracts a candidate area using the sensor information acquired from the dashcam 20. The candidate area extraction unit 110 may extract not one but a plurality of candidate areas. The candidate area may be any area as long as the area is used for determination of the investigation area. The investigation area is an area where sensor information is acquired using the dashcam 20 in order to investigate a disaster situation.

Therefore, for example, the candidate area extraction unit 110 may extract an area where sensor information is not acquired as the candidate area. Hereinafter, the area where the sensor information is not acquired is referred to as a “non-acquisition area”. For example, the candidate area extraction unit 110 may extract an area (non-acquisition area) where the sensor information is not acquired using the position information included in the sensor information acquired from the dashcam 20 and set the extracted non-acquisition area as the candidate area. Alternatively, the candidate area extraction unit 110 may determine an area where the sensor information has been acquired and set an area excluding the acquisition completion area as the candidate area. Hereinafter, an area where the sensor information has been acquired is referred to as an “acquisition completion area”.

The candidate area extraction unit 110 may extract, as the candidate area, an area satisfying a predetermined condition other than the acquisition of the sensor information. An example of the condition includes whether the vehicle can pass. For example, in a case where the sensor information acquisition device is mounted on a mobile body, an area where the mobile body on which the sensor information acquisition device is mounted cannot move is an area where the sensor information cannot be acquired. For example, the dashcam 20 mounted on the vehicle cannot acquire sensor information such as a narrow road through which the vehicle cannot pass or an unpaved road. Therefore, for example, in a case where the sensor information about the investigation area is acquired using the dashcam 20 mounted on the vehicle, the candidate area extraction unit 110 may extract a road through which the vehicle can pass as the candidate area.

Alternatively, the candidate area extraction unit 110 may exclude a road through which the vehicle cannot pass from the candidate area. For example, the candidate area extraction unit 110 may exclude a narrow road from the candidate area. As described above, the candidate area extraction unit 110 may extract, as the candidate area, an area where the mobile body on which the sensor information acquisition device is mounted such as the dashcam 20 can move. For example, the candidate area extraction unit 110 may extract, as the candidate area, an area where the vehicle on which the sensor information acquisition device is mounted such as the dashcam 20 can move. Hereinafter, an area where it is difficult to acquire sensor information from at least one of the functions of the sensor information acquisition device and the mobile body and that should be excluded from the investigation area is referred to as an “excluded area”.

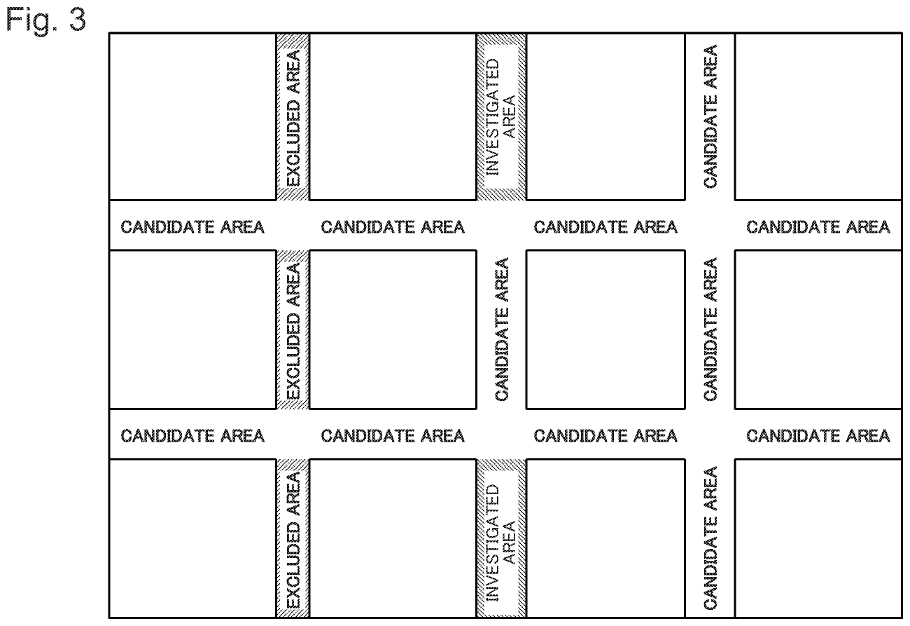

FIG. 3 is a diagram illustrating an example of a candidate area. FIG. 3 is a diagram for explaining a candidate area using a road as an example of the area. However, this is not intended to limit the candidate area of the first example embodiment to a road. The candidate area is not limited to the road, and may be an area other than the road. For example, the area other than the road may include at least one of an agricultural land, a parking lot, a park, an open space, a facility such as a factory, a bank, and a top end of an embankment. FIG. 3 includes three roads in the up-down direction and two roads in the left-right direction. Hereinafter, the three roads are referred to as “left, center, and right roads in the up-down direction”. Hereinafter, the two roads in the left-right direction are referred to as “upper and lower roads in the left-right direction”. The road in the up-down direction is divided into three sections with two roads in the left-right direction as boundaries. Hereinafter, the three sections are referred to as “upper, middle, and lower sections”. The road in the left-right direction is divided into four sections with three roads in the up-down direction as boundaries. Hereinafter, the four sections are referred to as “first, second, third, and fourth sections from right”. Since the intersection is included in a plurality of roads, description of the intersection is omitted in consideration of convenience of description except for a case where description is particularly necessary. In FIG. 3, in the central road in the up-down direction, upper and lower sections are acquisition completion areas. Therefore, the candidate area extraction unit 110 excludes this area from the candidate area.

The other sections of the road are non-acquisition areas. However, the road in the up-down direction on the left side is an excluded area because the road width is narrow in any of the upper, central, and lower sections, and it is difficult for vehicles to pass through the road. Therefore, the candidate area extraction unit 110 excludes these sections, which are areas where sensor information is not acquired, from the candidate areas. As a result, in FIG. 3, the candidate area extraction unit 110 extracts roads in areas other than the acquisition completion area and the excluded area as candidate areas. The description returns to the description with reference to FIG. 1.

A plurality of reasons is assumed as the reason why the sensor information in the non-acquisition area is not acquired. For example, the non-acquisition area includes an area where the sensor information is not to be acquired in a normal state. Hereinafter, an area where the sensor information is not to be acquired is referred to as a “non-investigation target area”. Alternatively, the non-acquisition area includes an area where the sensor information cannot be acquired although the sensor information is attempted to be acquired. For example, the area where the sensor information cannot be acquired may be a road where the vehicle cannot pass due to an influence of an obstacle or the like, or an area including an area ahead of the road. Hereinafter, an area where the sensor information cannot be acquired is referred to as an “acquisition disabled area”. There is a high possibility that a disaster has occurred in the acquisition disabled area. That is, the acquisition disabled area and its periphery should be preferentially included in the investigation area. Therefore, the candidate area extraction unit 110 may extract an acquisition disabled area in the non-acquisition area as the candidate area.

The method for determining the acquisition disabled area is not limited. For example, the candidate area extraction unit 110 may determine a returning point of the vehicle on which the dashcam 20 is mounted using the information included in the sensor information, and determine an area ahead of the determined returning point as an acquisition disabled area. For example, the candidate area extraction unit 110 may determine a returning point of the vehicle on which the dashcam 20 is mounted using the position information and the operation information about the mobile body, and determine an area ahead of the determined returning point as the acquisition disabled area. The candidate area extraction unit 110 may use information other than the above as the determination of the returning point. For example, the candidate area extraction unit 110 may determine the returning point using the additional information included in the sensor information. For example, the candidate area extraction unit 110 may determine the returning point using a comment of the operator. The candidate area extraction unit 110 may directly determine the acquisition disabled area based on a comment of the operator or the like. Specifically, the candidate area extraction unit 110 may determine the acquisition disabled area based on information about the presence or absence of an obstacle visually confirmed by the operator or the like.

The non-investigation target area will be described. Normally, in a case where the main road is monitored using the dashcam 20, the dashcam 20 acquires sensor information related to the main road. However, disasters can also occur outside the main roads. Therefore, using the disaster information, the candidate area extraction unit 110 may extract an area for newly acquiring the sensor information as a candidate area from among areas (non-investigation target areas) that have not been areas where the dashcam 20 acquires the sensor information until that time. As described above, the candidate area extraction unit 110 may extract an area where acquisition of sensor information is newly required in the non-investigation target area. Hereinafter, an area where sensor information is required to be newly acquired is referred to as a “new acquisition area”. The new acquisition area is an area included in the non-acquisition area.

The candidate area extraction unit 110 may extract a candidate area from among areas where sensor information has been acquired (acquisition completion areas) as at least some candidate areas. For example, even in an area where sensor information has been acquired, there may be an area where sensor information is insufficient for determining a disaster situation. Hereinafter, an area where sensor information is insufficient for determining a disaster situation is referred to as an “insufficient acquisition area”. The insufficient acquisition area is an area where at least part of the sensor information should be newly acquired. That is, the insufficient acquisition area is an area partially including an area corresponding to the new acquisition area. Therefore, the candidate area extraction unit 110 may determine the acquisition state of the sensor information in the acquisition completion area, extract the insufficient acquisition area using the acquisition state, and extract the extracted insufficient acquisition area as the candidate area.

Alternatively, there is a case where it is inappropriate to use the sensor information for disaster determination, such as a case where a certain period of time has elapsed since acquisition of the acquired sensor information. In such a case, it is better to acquire the sensor information again even in the area where the sensor information has already been acquired. Therefore, the candidate area extraction unit 110 may extract, as the candidate area, an area where the acquired sensor information satisfies a predetermined condition in the area where the sensor information has been acquired. For example, the candidate area extraction unit 110 may extract, as the candidate area, an area where the sensor information has been already acquired and where the acquisition time of the sensor information is before the occurrence of the disaster. As described above, the candidate area extraction unit 110 may extract an area for reacquiring at least part of the sensor information as the candidate area. Hereinafter, an area where at least part of the sensor information is reacquired is referred to as a “reacquisition area”.

At least part of the sensor information may be reacquired also in the insufficient acquisition area. That is, the insufficient acquisition area may be an area including an area (insufficient acquisition area) where sensor information insufficient as the determination of a disaster situation is acquired and a reacquisition area where sensor information is reacquired. The insufficient acquisition area and the reacquisition area can be regarded as an area where at least part of sensor information is not acquired as sensor information used for determining a disaster situation. Therefore, the insufficient acquisition area and the reacquisition area are also examples of the non-acquisition area. Therefore, in the following description, it is assumed that the non-acquisition area includes the reacquisition area and the insufficient acquisition area. As described above, the candidate area extraction unit 110 may extract one or a plurality of candidate areas from the non-acquisition area where the sensor information used for extracting the candidate area is not acquired using at least the sensor information.

The candidate area extraction unit 110 may set a priority to the candidate area. Hereinafter, the priority of the candidate area is referred to as a “candidate priority”. For example, the acquisition disabled area is an area where there is a high possibility that a disaster has occurred, and thus is an area where sensor information should be acquired when possible. Therefore, in a case where the acquisition disabled area is included in the candidate area, the candidate area extraction unit 110 may set the priority of the candidate area that is the acquisition disabled area among the candidate areas to be higher than the priority of the other candidate areas. For example, the candidate area extraction unit 110 may set the priority of the candidate area that is the acquisition disabled area among the candidate areas to be higher than the priority of the non-acquisition area that is not the acquisition disabled area. In a case where the user or the like sets the priority to a predetermined area in advance, the candidate area extraction unit 110 may use the priority set by the user or the like as the priority of the candidate area.

Alternatively, the candidate area extraction unit 110 may acquire disaster information from the information providing device 50 in addition to the sensor information, and extract a candidate area using the acquired disaster information. For example, when the disaster is a flood, the candidate area extraction unit 110 may extract the candidate area from the rainfall range. Alternatively, the candidate area extraction unit 110 may extract a candidate area using predetermined map information. For example, the candidate area extraction unit 110 may extract a candidate area using map information acquired from the information providing device 50. For example, the candidate area extraction unit 110 may extract a candidate area from a range having a high possibility of disaster in the hazard map. In these cases, the candidate area extraction unit 110 may set the priority to the candidate area using the information acquired from the information providing device 50. Then, the candidate area extraction unit 110 outputs the candidate area to the ground surface information acquisition unit 120 and the investigation area determination unit 130. The candidate area extraction unit 110 may output the acquired sensor information together with the candidate area to at least one of the investigation area determination unit 130 and the area output unit 140.

The ground surface information acquisition unit 120 acquires an SAR image related to the candidate area from the SAR 30. Then, the ground surface information acquisition unit 120 analyzes a change in the ground surface related to the candidate area using the acquired SAR image. Alternatively, the ground surface information acquisition unit 120 may acquire a change in the ground surface related to the candidate area from the SAR 30. As described above, although the subject of the analysis is different, the ground surface information acquisition unit 120 acquires a ground surface change that is a result of the analysis using the measurement result made by the ground surface measurement device in the candidate area. For example, the ground surface information acquisition unit 120 acquires a ground surface change that is a result of the analysis using an SAR image that is a measurement result made by the SAR 30.

The spatial resolution of the sensor information is often different from the spatial resolution of the SAR image. The boundary of the acquisition sections of the sensor information does not necessarily coincide with the boundary of the acquisition sections of the SAR image. That is, the ground surface information acquisition unit 120 cannot always acquire an SAR image in the same range as the candidate area. When the candidate area does not match the acquisition range of the SAR image, the ground surface information acquisition unit 120 may acquire an SAR image of a wider range including the candidate area, and analyze a change in the ground surface in the acquired SAR image. Alternatively, the ground surface information acquisition unit 120 may acquire, from the SAR 30, a change in the ground surface in a wider range including the candidate area.

The ground surface measurement device such as a multispectra measurement device may be able to provide a measurement result capable of analyzing the type of the ground surface. In this case, the ground surface information acquisition unit 120 may analyze the type of the ground surface using the information acquired from the SAR 30. Alternatively, the ground surface information acquisition unit 120 may acquire the type of the ground surface from the SAR 30. In these cases, the investigation area determination unit 130, which will be described later, may determine the investigation area using the type of the ground surface. Then, the ground surface information acquisition unit 120 outputs the acquired change in the ground surface to the investigation area determination unit 130. The acquired change in the ground surface may include a type of the ground surface.

The investigation area determination unit 130 determines an investigation area in the candidate area using the acquired change in the ground surface. The investigation area determination unit 130 may determine a plurality of investigation areas. The investigation area determination unit 130 determines a range in which investigation is possible based on a change in the ground surface. Hereinafter, the range that can be investigated is referred to as an “investigatable range”. Then, the investigation area determination unit 130 determines an area that is both the investigatable range and the candidate area as an investigation area. Alternatively, the investigation area determination unit 130 may extract a change in the ground surface related to the candidate area from the acquired change in the ground surface, determine an investigatable range in the extracted change in the ground surface, and determine the determined investigatable range as the investigation area.

A method of determining the investigatable area in the investigation area determination unit 130 is not particularly limited. For example, the investigation area determination unit 130 may determine the investigatable range using a value of a change in the ground surface, or may determine the investigatable range using a change in a value of a change in the ground surface. The value of the change in the ground surface is, for example, an absolute value of the value. The change in the value of the change in the ground surface is, for example, a change rate. The investigation area is an area where sensor information is acquired using the dashcam 20 as a disaster situation investigation. For example, the investigation area is an area where a person in charge of a local government or the like carries the dashcam 20 and acquires sensor information. Therefore, the investigation area determination unit 130 may determine an area having a low risk associated with a disaster as the investigation area.

For example, an area where the change in the ground surface is large is an area where the damage of the disaster is large or the future damage is likely to expand. The investigation in such areas is often highly risky. Therefore, the investigation area determination unit 130 may determine, as the investigation area, an area where a change in the ground surface is smaller than a threshold value among the candidate areas. That is, the investigation area determination unit 130 may determine an area having a low risk among the candidate areas as the investigation area. However, it is desirable that the investigation area is an area where a disaster situation can be determined as much as possible. Therefore, the investigation area determination unit 130 may determine, as the investigation area, an area included in a range of a predetermined distance from an area where a change in the ground surface is larger than a predetermined value. For example, the investigation area determination unit 130 may determine, as the investigation area, a peripheral area of an area having a large change in the ground surface.

Alternatively, the investigation area may be an area where a person in charge of the local government moves a vehicle equipped with the dashcam 20 as the investigation. In this case, the investigation area is required to be passable by a vehicle. For example, in a case the candidate area extraction unit 110 extracts a candidate area that allows vehicle traffic as at least part of the candidate area, the investigation area determination unit 130 may determine the investigation area from the candidate areas that allows vehicle traffic. However, the candidate area extraction unit 110 may not consider whether a mobile body such as a vehicle can pass in extracting the candidate area. In this case, the investigation area determination unit 130 may determine an area where a mobile body such as a vehicle is passable in the acquired candidate area or the area of the change in the ground surface, and determine the investigation area based on the determined area. As described above, in the investigation area determination device 10, the configuration for determining whether a mobile body such as a vehicle can pass is not limited to the candidate area extraction unit 110.

The investigation area determination unit 130 may use the type of the ground surface in addition to the change in the ground surface. For example, in the case of a flood, an area where the water has not receded is an area that is difficult to investigate. Therefore, the investigation area determination unit 130 may exclude an area where the type of the ground surface is a water surface from the investigation area. Alternatively, the range where the ground surface is covered with garbage and mud is likely to be an area where the flood has receded. Therefore, the investigation area determination unit 130 may determine a range in which the type of the ground surface is at least one of garbage and mud as the investigation area.

The investigation area determination unit 130 may use the sensor information in addition to the change in the ground surface in the determination of the investigation area. For example, in a case where the image that is the sensor information includes the water surface of the flood, the investigation area determination unit 130 may determine the position of the water surface using the sensor information, and exclude the position of the water surface and its peripheral area from the investigation area. As described above, the investigation area determination unit 130 may determine the risk of investigation in the candidate area using the sensor information in addition to the change in the ground surface, and determine the investigation area from the candidate area with a low risk.

Furthermore, the investigation area determination unit 130 may determine an area where it is better to avoid investigation using at least one of a change in the ground surface and sensor information. That is, the investigation area determination unit 130 may determine an area where acquisition of the sensor information in the disaster situation investigation should be avoided using at least one of the change in the ground surface and the sensor information. Hereinafter, an area where an investigation should be avoided is referred to as a “hazardous area”. For example, there is a high possibility that an area where the change in the ground surface is large is an area where the damage of the disaster is large. Therefore, the investigation area determination unit 130 may determine an area where the change in the ground surface is larger than a predetermined threshold value as the hazardous area. Alternatively, the investigation area determination unit 130 may determine the hazardous area using the disaster-stricken state included in the sensor information. For example, the investigation area determination unit 130 may determine the hazardous area using flooding or a depression of a road surface included in the image. For example, the investigation area determination unit 130 may determine a state of a pot hole or a depression of a road surface using an image of the road surface, and determine a road on which it is difficult for the vehicle to travel as a hazardous area.

Alternatively, the investigation area determination unit 130 may determine the possibility of occurrence of a secondary disaster, and determine a building having the determined high possibility of the secondary disaster and its periphery as a hazardous area. For example, the investigation area determination unit 130 may determine a building having a high possibility of collapse and its periphery as a hazardous area. A method of determining the possibility of occurrence of a secondary disaster may be set in advance by the user or the like in the investigation area determination device 10. For example, the investigation area determination unit 130 may determine the possibility of occurrence of a secondary disaster such as building collapse using the building collapse situation included in the image that is the sensor information.

Furthermore, the investigation area determination unit 130 may determine the hazardous area using the type of the ground surface in addition to the change in the ground surface. For example, the investigation area determination unit 130 may determine an area where the type of the ground surface is a water surface as the hazardous area. The investigation area determination unit 130 may determine that the area including a prescribed range around the area determined to be dangerous as described above in consideration of safety is a hazardous area. Alternatively, there is a high possibility that a disaster has occurred in the acquisition disabled area. Therefore, the investigation area determination unit 130 may determine the acquisition disabled area as a hazardous area. As described above, the hazardous area is an area that is determined using at least one of a change in the ground surface and sensor information and in which it is determined that it is better to avoid investigation.

Alternatively, the investigation area determination unit 130 may determine the hazardous area using information acquired from the information providing device 50 or the like in addition to or in place of the change in the ground surface and the sensor information. For example, the investigation area determination unit 130 may acquire information related to a road from the information providing device 50, and determine a highly dangerous place in the road as a hazardous area. For example, the investigation area determination unit 130 may determine a tunnel, a bridge, or a road having a steep terrain such as a cliff on at least one side as a place having a high risk. Alternatively, the investigation area determination unit 130 may determine the hazardous area using information related to weather or fire. For example, the investigation area determination unit 130 may determine the hazardous area using a rainfall range and an amount of rainfall prediction, or information related to a region where a fire has occurred and a wind direction. Alternatively, the investigation area determination unit 130 may determine the hazardous area using the map information acquired from the information providing device 50. For example, the investigation area determination unit 130 may determine the hazardous area using a hazard map including a dangerous area such as a river or a cliff acquired from the information providing device 50.

In a case where the information acquired from the information providing device 50 or the like is used, the investigation area determination unit 130 may change a threshold value used for determination of at least one of a change in the ground surface and the sensor information in the determination of the hazardous area using the acquired information. For example, the vicinity of a cliff or a slope (slope surface) is more likely to cause landslides than a flat land. Therefore, the investigation area determination unit 130 may make a threshold value used for determination of a change in the ground surface smaller in a flat land than in the vicinity of a cliff or a slope determined based on topographical information acquired from the information providing device 50 or the like.

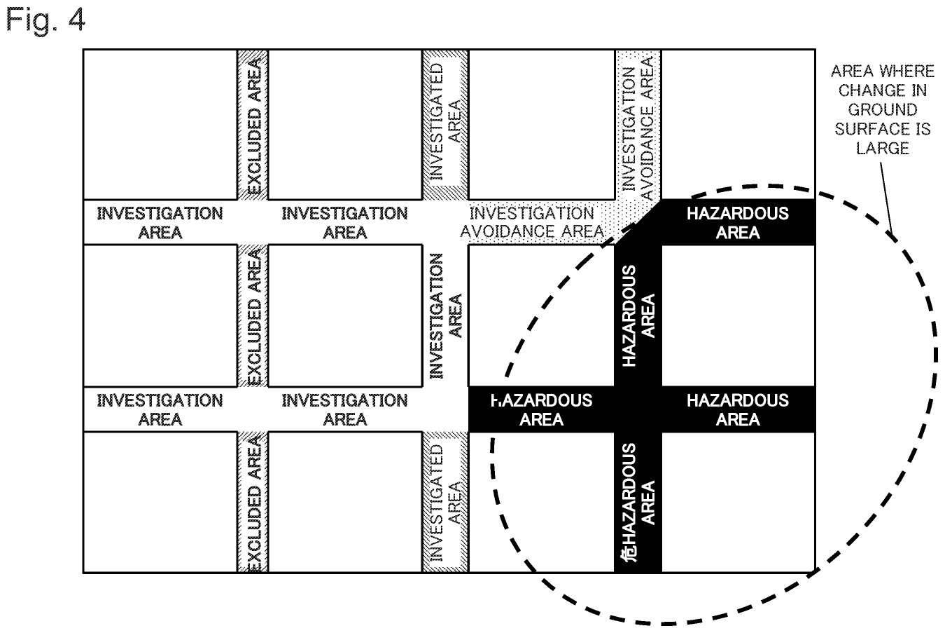

FIG. 4 is a diagram for describing an investigation area and a hazardous area. In FIG. 4, a lower right elliptical area is an area where a change in the ground surface is large. For example, an area with a large change in the ground surface is a range of flooding. Therefore, the investigation area determination unit 130 determines a section of the road included in this range as a hazardous area. Most of the upper section of the road in the up-down direction on the right side and the second section from the right of the road in the left-right direction on the upper side are not included in the area where the change in the ground surface is large. However, the intersection on one side of each of the two sections is included in an area where the change in the ground surface is large. Therefore, in a case where the vehicle on which the dashcam 20 is mounted enters such a section in order to acquire the sensor information, there is a possibility that the vehicle cannot proceed and the investigation cannot be performed. That is, such an area is an area where there is a high possibility that the investigation cannot be performed. Therefore, the investigation area determination unit 130 may exclude such an area from the investigation area. Hereinafter, an area that is not included in the hazardous area but is determined to be better to avoid the investigation based on a change in the ground surface or the like is referred to as an “investigation avoidance area”. In FIG. 3, the investigation area determination unit 130 determines a candidate area remaining excluding the hazardous area and the investigation avoidance area as the investigation area. The description returns to the description with reference to FIG. 1.

The investigation area determination unit 130 may determine the risk level of the hazardous area using at least one of a change in the ground surface, sensor information, and information acquired from the information providing device 50. For example, the investigation area determination unit 130 may set several ranges according to the magnitude of the change in the ground surface, and set the risk level for each range. The risk level is, for example, large/medium/small. Alternatively, in a case where the area determined to be dangerous and its peripheral area are determined to be a hazardous area, the investigation area determination unit 130 may increase the risk level of the area determined to be dangerous relative to the risk level of the peripheral area.

The investigation area determination unit 130 may set the priority of the investigation in at least part of the investigation area using at least one of sensor information related to the investigation area and a change in the ground surface. Hereinafter, the priority of the investigation area is referred to as an “investigation priority”. For example, the hazardous area and the investigation avoidance area are areas where the degree of disaster is likely to be high, and are areas to be preferentially investigated including the periphery if possible. Therefore, the investigation area determination unit 130 may increase the priority of the investigation area adjacent to at least one of the hazardous area and the investigation avoidance area. Alternatively, the investigation area determination unit 130 may increase the priority of the acquisition disabled area or the insufficient acquisition area. Alternatively, the investigation area determination unit 130 may use the priority (candidate priority) of the candidate area set by the candidate area extraction unit 110 as the priority (investigation priority) of the investigation area.

Alternatively, the investigation area determination unit 130 may set the priority of the investigation area using the type of the ground surface. For example, there is a high possibility that it is difficult for a vehicle or the like to pass through an area of garbage as compared with an area of mud having less garbage. Hereinafter, an area of mud having little garbage (including a case where there is no garbage and a case where there is a small amount of garbage) is referred to as an “area of mud”. Therefore, for example, the investigation area determination unit 130 may set the priority of the mud area to be higher than the priority of the garbage area. Alternatively, in a case where the user or the like sets the priority to at least some types of the ground surface in advance, the investigation area determination unit 130 may use the priority of the set type of the ground surface.

Alternatively, the investigation area determination unit 130 may set the priority using the sensor information in the peripheral area of the area where the sensor information cannot be acquired (acquisition disabled area). For example, in a case where there is a plurality of investigation areas including a point where the vehicle has returned in the acquisition of the sensor information, the investigation area determination unit 130 may determine the degree of disaster at each returning point using an image at the returning point, and set a priority to the investigation area based on the degree of disaster.

Alternatively, the investigation area determination unit 130 may set the priority using the additional information included in the sensor information. For example, the investigation area determination unit 130 may set the priority using the comment of the operator included in the sensor information. For example, the comment of the operator included in the sensor information may include a comment related to necessity of investigation such as necessity of investigation, necessity of reinvestigation, and non-necessity of investigation. Alternatively, the investigation area determination unit 130 may determine the disaster-stricken state of the road using the sensor information, and set the priority according to the disaster-stricken state of the road. For example, the investigation area determination unit 130 may determine how much the road surface is destroyed, and set the priority according to the disaster-stricken state of the road. Alternatively, the investigation area determination unit 130 may use the priority set for each reason that the vehicle cannot pass through an impassable road. For example, the investigation area determination unit 130 may use the priority set for each of flooding, cracking, depressions, fallen trees, and the like, which are reasons for impassability. In this case, the user or the like may set the priority in the investigation area determination device 10 in advance.

Furthermore, the investigation area determination unit 130 may determine at least one of the type of a disaster and the disaster range using at least one of the sensor information and the change in the ground surface. For example, the sensor information may include information that can be used to determine the type of a disaster. For example, the information that can be used to determine the type of a disaster may be the water surface of the flood in the image. Therefore, the investigation area determination unit 130 may determine the type of a disaster using the sensor information. For example, in a case where the image acquired as the sensor information includes the water surface of the flood, the investigation area determination unit 130 may determine that the type of a disaster is the flood using the image. The water surface of the flood may be, for example, flooding of a road. Furthermore, in a case where images that are a plurality of pieces of sensor information includes flooding of a road, the investigation area determination unit 130 may determine the range of the flood using the positions of the pieces of sensor information.

Alternatively, a change in acceleration caused by an earthquake is often different from a change in acceleration caused by traveling of the vehicle. Therefore, the investigation area determination device 10 may determine the occurrence of an earthquake using the acceleration acquired by the dashcam 20. Further, the investigation area determination unit 130 may acquire the acceleration from each of the plurality of dashcams 20, and determine the approximate position of the seismic source and the seismic intensity using the detection time and the magnitude of the acquired acceleration and the position of each dashcam 20. Then, the investigation area determination unit 130 may determine the disaster range using the position of the seismic source and the seismic intensity.

The type of a disaster determined by the investigation area determination unit 130 is not limited. For example, the disaster is a sediment disaster or a flood damage. For example, the sediment disaster is a slope collapse, a mountain collapse, a rock collapse, a debris flow, a land slide, or the like. Alternatively, the flood damage is a flood, a flood of a river, water immersion, a high tide, a tsunami, or the like. Alternatively, the disaster is an earthquake and a disaster caused by an earthquake, or a volcanic eruption and a disaster caused by the volcanic eruption. The disaster caused by the earthquake is a tsunami, building collapse, fire occurrence, soil collapse, a liquefaction phenomenon, or the like. The disaster caused by the volcanic eruption is a volcanic rock, a pyroclastic flow, a snowy volcanic mud flow, a lava flow, volcanic ash, volcanic gas, or the like. However, the disaster may be not only a natural disaster such as a sediment disaster, a flood damage, an earthquake, or a volcanic eruption, but also a human disaster such as a fire, a traffic accident, a factory explosion, or an explosive terrorism.

Then, the investigation area determination unit 130 outputs the determined investigation area to the area output unit 140. The investigation area determination unit 130 may output the priority (investigation priority) of the investigation area in association with the investigation area. The investigation area determination unit 130 may output the hazardous area. The investigation area determination unit 130 may output the risk level in association with the hazardous area. The investigation area determination unit 130 may output at least one of the type of a disaster and the range of disaster. Further, the investigation area determination unit 130 may output sensor information related to at least one of the investigation area and the hazardous area. Furthermore, the investigation area determination unit 130 may output a change in the ground surface related to at least one of the investigation area and the hazardous area. The change in the ground surface may include a type of ground surface. The investigation area determination unit 130 may further output a candidate area.

At least one of the candidate area extraction unit 110, the ground surface information acquisition unit 120, and the investigation area determination unit 130 may use predetermined image recognition. In the present example embodiment, the image recognition is not limited. For example, the image recognition includes recognition using a determination model, recognition using another method, and recognition combining them. For example, the user or the like executes machine training using information collected in advance as teacher data, and generates a determination model for extracting a candidate area as a result of the machine training. The information collected in advance is, for example, an image of a road or an SAR image. Then, the user or the like stores the generated determination model in the investigation area determination device 10.

Then, for example, in a case where a determination model generated using the sensor information is stored, the candidate area extraction unit 110 applies the acquired sensor information to the stored determination model to extract a candidate area. The sensor information is, for example, an image of a road. Alternatively, when a determination model generated using the SAR image is stored, the ground surface information acquisition unit 120 applies the acquired SAR image to the stored determination model to acquire a change in the ground surface. Alternatively, in a case where a determination model generated using a change in the ground surface is stored, the investigation area determination unit 130 applies a change in the ground surface related to the candidate area to the stored determination model to determine the investigation area.

Furthermore, in the case of using image recognition, at least one of the candidate area extraction unit 110, the ground surface information acquisition unit 120, and the investigation area determination unit 130 may calculate the certainty of the result of image recognition. Furthermore, at least one of the candidate area extraction unit 110, the ground surface information acquisition unit 120, and the investigation area determination unit 130 may determine the rank of the calculated certainty. The rank is, for example, a high/medium/low certainty. Then, at least one of the candidate area extraction unit 110, the ground surface information acquisition unit 120, and the investigation area determination unit 130 may output at least one of the certainty and the rank together with the investigation area to the area output unit 140.

The area output unit 140 outputs the investigation area determined by the investigation area determination unit 130. The area output unit 140 may output the priority (investigation priority) of the investigation area together with the investigation area. Further, the area output unit 140 may output the investigation area in association with the map information. For example, the area output unit 140 may acquire the hazard map from the information providing device 50 to output the investigation area in association with the hazard map. Alternatively, the area output unit 140 may further acquire information about a structure requiring attention at the time of investigation in the investigation area, and output the information in association with the investigation area. For example, structures that require attention at the time of investigation may include the inlet and outlet of a tunnel, a bridge, and a building that may fall. The building that may fall may include, for example, a bronze statue and a bulletin board.

In the output of the investigation area, the area output unit 140 may output at least one of sensor information and a change in the ground surface related to the investigation area in association with each other. For example, the sensor information may be an image. Alternatively, the area output unit 140 may output the measurement time of the measurement result made by the SAR 30 that has analyzed the change in the ground surface. Measurement by the SAR 30 may have an acquisition cycle longer than that of sensor information by the dashcam 20. Therefore, the investigation area determination device 10 may output the acquisition time (or measurement time) for acquiring the measurement result made by the SAR 30 as temporal information related to the determination of the investigation area for the user or the like.

The area output unit 140 may output disaster information related to the investigation area. For example, in the case of a flood, the area output unit 140 may output the amount of rainfall at each point including the upstream of the river acquired from a predetermined device in association with the investigation area. For example, the amount of rainfall may be a change in the amount of rainfall from the past, a transition of the total amount of rainfall from the beginning of the precipitation, and the like.” The area output unit 140 may output not only rain but also other weather information in association with the investigation area. The weather information may be, for example, information related to snow or the like. Alternatively, in the case of an earthquake, the area output unit 140 may acquire a seismic source, seismic intensity in each of different areas, and an occurrence situation of an aftershock from an organization providing earthquake information, and output them in association with the investigation area. Alternatively, in the case of a wide-area fire, the area output unit 140 may acquire the fire spreading range, the wind direction, the wind volume, and the like, and output them in association with the investigation area. Alternatively, the area output unit 140 may acquire the situation of the social infrastructure to output the situation in association with the investigation area. The situation of the social infrastructure may be, for example, a situation of a power outage, a water outage, or a supply stop of city gas. Alternatively, when the investigation area determination unit 130 determines the possibility of the secondary disaster, the area output unit 140 may output the determined possibility of the secondary disaster in association with the investigation area.

The area output unit 140 may output the hazardous area. The area output unit 140 may output the risk level in association with the hazardous area. Alternatively, the area output unit 140 may output information output in association with the above-described investigation area in association with the hazardous area. For example, the area output unit 140 may output the disaster information in association with the hazardous area. Furthermore, the area output unit 140 may output a change in the ground surface related to at least one of the hazardous area and its peripheral area.

Furthermore, the area output unit 140 may output sensor information related to at least one of the hazardous area and its peripheral area. The hazardous area is, for example, an area which a vehicle or the like cannot enter due to an obstacle or the like. Therefore, in many cases, the dashcam 20 mounted on the vehicle has not been able to acquire the sensor information in the hazardous area. However, there is a case where the dashcam 20 mounted on the vehicle may be able to acquire the sensor information in the peripheral area of the hazardous area. Alternatively, a fixed camera or the like installed on a rooftop of a building or the like may be able to acquire sensor information about a hazardous area or the periphery of the hazardous area. Therefore, when acquiring the sensor information related to at least one of the hazardous area and its peripheral area, the area output unit 140 may output the sensor information related to at least one of the hazardous area and its peripheral area. In this case, the user or the like can grasp the situation of the hazardous area or the like by referring to the output sensor information.

The investigation area determination device 10 may acquire information related to at least one of the investigation area and the hazardous area from a predetermined device to store it. For example, the display device 40 may display sensor information about at least one of the investigation area and the hazardous area and acquire a comment on at least one of the investigation area and the dangerous information from the user. In this case, the investigation area determination device 10 may acquire the comment on at least one of the investigation area and the hazardous area from the display device 40, and store the comment in association with at least one of the investigation area and the hazardous area. Then, in a case where the comment is requested, the investigation area determination device 10 may output the comment in association with at least one of the investigation area and the hazardous area.

Then, the display device 40 displays the information output by the area output unit 140. The display device 40 may change information to be displayed in response to a request from the user. For example, the display device 40 first displays the investigation area. Then, the display device 40 may appropriately display at least one of the priority (investigation priority) of the investigation area, the hazardous area, the risk level of the hazardous area, the candidate area, the non-acquisition area, the change in the ground surface, and the sensor information in response to the request from the user or the like. Alternatively, when the investigation area determination device 10 uses the determination model, the display device 40 may display the certainty or the rank of the determination using the determination model in response to a request from the user or the like. At this time, the display device 40 may make a request of the investigation area determination device 10 for the information to be displayed, or may acquire the information in advance and change the display in response to the request.

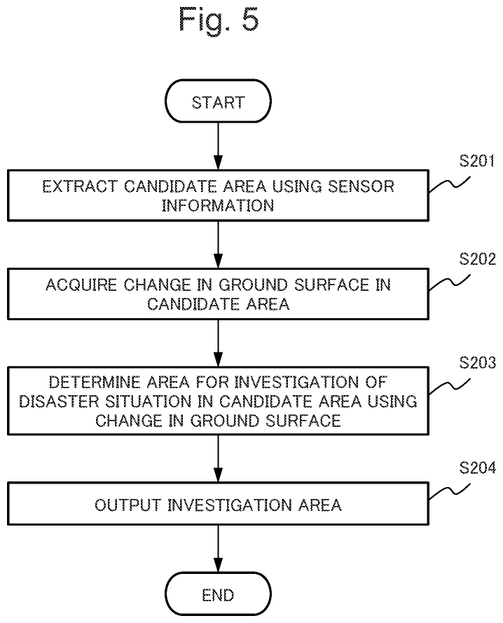

Next, an operation of the investigation area determination device 10 according to the first example embodiment will be described with reference to the drawings. FIG. 5 is a flowchart illustrating an example of the operation of the investigation area determination device 10 according to the first example embodiment. The candidate area extraction unit 110 extracts a candidate area for investigation of a disaster situation using the sensor information acquired by the dashcam 20 (step S201). The ground surface information acquisition unit 120 acquires a ground surface change that is a result of an analysis using the measurement result made by the SAR 30 in the candidate area (step S202). The investigation area determination unit 130 determines an investigation area for investigation of a disaster situation in a candidate area using a ground surface change (step S203). Then, the area output unit 140 outputs the investigation area to a predetermined device (step S204). The predetermined device is, for example, the display device 40.

The investigation area determination device 10 configured as described above can determine an appropriate investigation area. The reason is as follows. The investigation area determination device 10 includes the candidate area extraction unit 110, the ground surface information acquisition unit 120, and the investigation area determination unit 130. The candidate area extraction unit 110 extracts a candidate area for investigation of a disaster situation using the sensor information acquired by the sensor information acquisition device. The ground surface information acquisition unit 120 acquires a ground surface change that is a result of an analysis using the measurement result made by the ground surface measurement device in the candidate area. The investigation area determination unit 130 determines the investigation area for investigation of the disaster situation in the candidate area using the ground surface change. The sensor information acquisition device is, for example, the dashcam 20. The acquired sensor information is, for example, an image. The ground surface measurement device is, for example, the SAR 30. The measurement result is, for example, an SAR image.

The determination using the sensor information acquired by the sensor information acquisition device such as the dashcam 20 has sufficient accuracy in the determination of the disaster situation, from several centimeters to several tens of centimeters. Therefore, the investigation area determination device 10 can extract a candidate area for investigation within an appropriate accuracy range using the sensor information. The ground surface measurement device such as the SAR 30 can measure an area where a disaster has occurred. Therefore, the investigation area determination device 10 can determine an appropriate area as the investigation area including the area where the sensor information cannot be acquired using the ground surface change. For example, since the technique described in PTL 2 uses an image captured by an imaging unit mounted on a vehicle, an image for determination cannot be acquired for an area where the vehicle cannot pass. However, using a change in the ground surface that is a result of analysis on the measurement result acquired from the SAR 30, the investigation area determination device 10 can determine an area appropriate as an investigation area, including an area where sensor information cannot be acquired.

The candidate area may include a non-acquisition area where sensor information used for extraction of the candidate area is not acquired. The non-acquisition area is an area where sensor information is not acquired, and is an area where acquisition of new sensor information is desired. Therefore, the investigation area determination device 10 can extract an appropriate candidate area using the non-acquisition area. The candidate area may include an area where the sensor information in the non-acquisition area cannot be acquired (acquisition disabled area). The acquisition disabled area is an area where there is a high possibility that a disaster has occurred. Therefore, the investigation area determination device 10 can extract an appropriate candidate area by including an area (acquisition disabled area) where the sensor information cannot be acquired.

Further, the candidate area may be an area where the mobile body on which the sensor information acquisition device is mounted can move. The sensor information acquisition device is, for example, the dashcam 20. The mobile body is, for example, a vehicle. In this case, the investigation area determination device 10 can determine a candidate area where the sensor information can be acquired using the mobile body on which the sensor information acquisition device is mounted. The investigation area is an area determined from the candidate area. That is, the investigation area determination device 10 can determine the investigation area that can be investigated using the mobile body. As a result, the user or the like can quickly execute the investigation while reducing the investigation load using the mobile body.

Furthermore, the mobile body on which the sensor information acquisition device is mounted may be a vehicle. The sensor information acquisition device is, for example, the dashcam 20. In this case, the investigation area determination device 10 can determine the investigation area where the vehicle can travel. As a result, the user or the like can execute the investigation more quickly using the vehicle. For example, in a case where the dashcam 20 mounted on the vehicle is used as road condition monitoring in a normal state, the user can conduct an investigation such as acquisition of sensor information without requiring preparation work or the like. The sensor information may include at least one of an image, a speed, acceleration, and a distance. These pieces of information are easily acquired using a general sensor information acquisition device. The sensor information acquisition device is, for example, the dashcam 20. Therefore, the investigation area determination device 10 can determine an investigation area that can be investigated using information that can be easily acquired. The ground surface measurement device may be a synthetic aperture radar. The synthetic aperture radar is, for example, the SAR 30. Currently, a plurality of available synthetic aperture radars is in operation. Therefore, the investigation area determination device 10 can appropriately acquire the change in the ground surface using the measurement result of the measurement period.

The candidate area extraction unit 110 may extract a candidate area using disaster information. In this case, the investigation area determination device 10 can extract a candidate area in consideration of the disaster information in addition to the sensor information. The disaster information may be information including at least one of a rainfall range, an amount of rainfall, rain cloud information, a wind direction, a wind volume, a seismic source, seismic intensity, a situation of an aftershock, a power outage, a water outage, a map related to a disaster, a disaster range, a secondary disaster, and past disaster information. These pieces of information are information appropriate as disaster information.

The investigation area determination unit 130 may determine an investigatable area using a ground surface change, and determine an investigatable area based on the investigation area and the candidate area. In this case, even when the candidate area is different from the range of the SAR image that can be acquired, the investigation area determination device 10 can determine the investigatable area as the investigation area. The investigation area determination unit 130 may set a priority (investigation priority) in the investigation area using at least one of the ground surface change and the sensor information. In this case, the user or the like can create an investigation plan or the like using the priority of the investigation area. That is, the investigation area determination device 10 can improve the convenience of the user. The investigation area determination unit 130 may determine the investigation area using the type of the ground surface. In this case, the investigation area determination device 10 can more accurately determine the investigation area.

The investigation area determination unit 130 may determine a hazardous area that is an area where it is better to avoid investigation using at least one of the ground surface change and the sensor information. The user or the like can use the hazardous area to investigate safety in the investigation. That is, the investigation area determination device 10 can determine the information contributing to the improvement of the safety of the user based on the above configuration. An area where the ground surface change is larger than a predetermined value and an area where the sensor information includes information related to danger are areas that are highly likely to be dangerous. Therefore, the investigation area determination device 10 may determine at least one of an area where the ground surface change is larger than a predetermined value and an area where the sensor information includes information related to danger as the hazardous area. In this case, the investigation area determination device 10 can determine an area assumed to have a high risk as a hazardous area.

The investigation area determination unit 130 may determine the risk level of the hazardous area using at least one of the ground surface change and the sensor information. For example, in a case where there is a plurality of hazardous areas, the user or the like can compare the hazardous areas using the risk level. In this manner, the investigation area determination device 10 can determine the risk level which is information for comparing the hazardous areas. Furthermore, the investigation area determination unit 130 may determine the hazardous area using the type of the ground surface. In this case, the investigation area determination device 10 can determine the hazardous area more accurately.

The investigation area determination unit 130 may determine the type of a disaster using at least one of the sensor information and the ground surface change. In this case, the investigation area determination device 10 can determine the type of a disaster in the investigation area. Alternatively, the investigation area determination unit 130 may determine the disaster range using at least one of the sensor information acquired in the investigation area and the ground surface change. In this case, the investigation area determination device 10 can determine the range of disaster in the investigation area. In this manner, the investigation area determination device 10 can determine at least one of the type and the range of the disaster as the information related to the disaster using at least one of the sensor information and the ground surface change.

The investigation area determination device 10 may include the area output unit 140 that outputs the investigation area. In this case, the investigation area determination device 10 can provide the investigation area to a predetermined device. The area output unit 140 may output the investigation area and the hazardous area. In this case, the investigation area determination device 10 can provide the user with the hazardous area as the additional information related to the danger in the investigation. For example, the user or the like can go to the investigation area while avoiding the hazardous area.

The area output unit 140 may output the investigation area and the priority (investigation priority) of the investigation area. In this case, the investigation area determination device 10 can provide the user or the like with a priority that is effective information for proceeding with the investigation. For example, the user may start the investigation from an area having a high priority among the investigation areas. The area output unit 140 may output the investigation area and the non-acquisition area. Also in this case, the investigation area determination device 10 can provide the user or the like with a non-acquisition area that is effective information for proceeding with the investigation. For example, the user may start the investigation from a non-acquisition area among the investigation areas. In this manner, the investigation area determination device 10 may provide the user with effective information.

The area output unit 140 may output sensor information in the investigation area. Alternatively, the area output unit 140 may output a ground surface change in the investigation area. In these cases, the investigation area determination device 10 can provide the user or the like with effective information related to the investigation area. For example, the user may check the state of the investigation area before the investigation by referring to at least one of the sensor information and the ground surface change. The user may check an image or the like related to the investigation area before the investigation, and then investigate whether it is necessary to perform the investigation. For example, the user may check the image related to the investigation area before the investigation and stop the investigation when the user determines that it is difficult to conduct the investigation.

Alternatively, the area output unit 140 may output the candidate area. The candidate area is an area to be a candidate for an investigation area to be investigated using the sensor information. Then, the investigation area is an area determined to be investigatable in the candidate area based on a change in the ground surface. On the other hand, a candidate area that has not been determined to be an investigation area is an area that has not been determined to be investigatable based on a change in the ground surface. For example, in a case where the investigation area determination unit 130 determines, based on a change in the ground surface, an area having a low risk associated with a disaster as the investigation area, a candidate area that has not been determined to be investigatable is an area having a high risk associated with a disaster. For example, an investigation area whose surroundings are entirely surrounded by candidate areas is an area (that is, a highly hazardous area) where all candidate areas around the investigation area have been determined not to be investigatable. In this way, when the candidate area and the investigation area are used, for example, the user can grasp that the investigation area whose periphery is entirely surrounded by the candidate area is an area inappropriate for investigation (that is, a highly hazardous area) in the periphery of the investigation area. For example, when the user goes to the investigation area, the user is required to pay attention to a disaster state or the like in the periphery of the investigation area. In this manner, the investigation area determination device 10 may provide the user with a candidate area that is effective information.

The area output unit 140 may output the measurement time of the measurement result used to analyze the ground surface change used to determine the investigation area. The measurement result is, for example, an SAR image. For example, the update cycle of the measurement of the SAR 30 may be long to some extent. The user or the like can determine validity or the like of the determined investigation area with reference to the measurement time. The area output unit 140 may output disaster information related to the investigation area. In this case, the investigation area determination device 10 can provide the user or the like with disaster information related to the investigation area. The user or the like can determine whether to perform an investigation with reference to the disaster information.

The investigation area determination system 80 includes the investigation area determination device 10, the sensor information output device, the ground surface measurement device, and the display device 40. The sensor information output device is, for example, the dashcam 20. The ground surface measurement device is, for example, the SAR 30. The investigation area determination device 10 operates as described above. The sensor information output device outputs the sensor information to the investigation area determination device 10. The ground surface measurement device outputs a measurement result to the investigation area determination device 10. The display device 40 acquires the investigation area from the investigation area determination device 10 to display it. The investigation area determination system 80 configured as described above can provide the user or the like with an appropriate investigation area.

Next, a hardware configuration of the investigation area determination device 10 will be described. Each component of the investigation area determination device 10 may be configured by a hardware circuit. Alternatively, in the investigation area determination device 10, each component may be configured using a plurality of devices connected via a network. For example, the investigation area determination device 10 may be configured using cloud computing. Alternatively, in the investigation area determination device 10, the plurality of components may be configured by one piece of hardware. Alternatively, the investigation area determination device 10 may be achieved as a computer device including a central processing unit (CPU), a read only memory (ROM), and a random access memory (RAM). In addition to the above configuration, the investigation area determination device 10 may be achieved as a computer device including a network interface circuit (NIC).

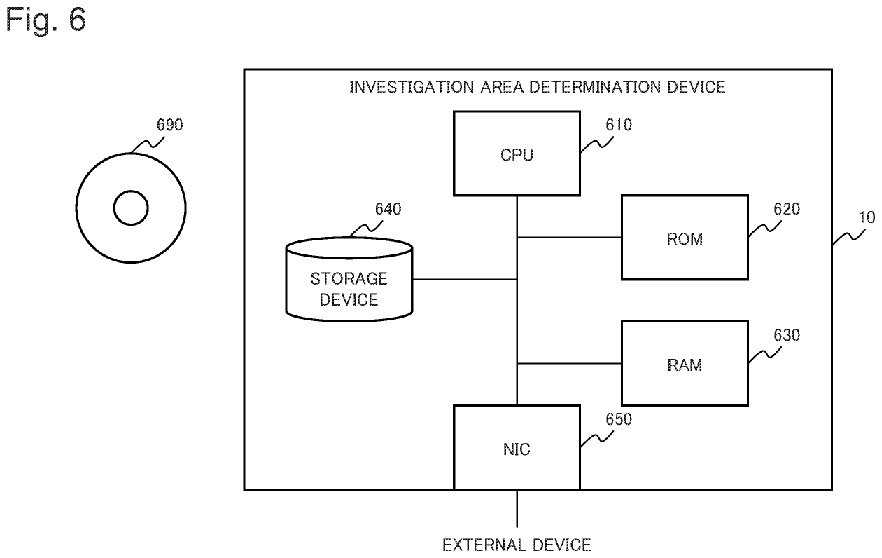

FIG. 6 is a block diagram illustrating an example of a hardware configuration of the investigation area determination device 10. The investigation area determination device 10 includes a CPU 610, a ROM 620, a RAM 630, a storage device 640, and an NIC 650, and constitutes a computer device. The CPU 610 reads a program from at least one of the ROM 620 and the storage device 640. Then, the CPU 610 controls the RAM 630, the storage device 640, and the NIC 650 based on the read program. Then, the computer including the CPU 610 controls the configuration, and implements functions as the candidate area extraction unit 110, the ground surface information acquisition unit 120, the investigation area determination unit 130, and the area output unit 140 illustrated in FIG. 1.

When implementing each function, the CPU 610 may use at least one of the RAM 630 and the storage device 640 as a temporary storage medium of a program and data. The CPU 610 may read the program included in a recording medium 690 storing the program in a computer readable manner using a recording medium reading device (not illustrated). Alternatively, the CPU 610 may receive a program from an external device (not illustrated) via the NIC 650, store the program in at least one of the RAM 630 and the storage device 640, and operate based on the stored program.

The ROM 620 stores programs executed by the CPU 610 and fixed data. The ROM 620 is, for example, a programmable-ROM (P-ROM) or a flash ROM. The RAM 630 temporarily stores at least one of a program executed by the CPU 610 and data. The RAM 630 is, for example, a dynamic-RAM (D-RAM). The storage device 640 stores data and programs to be stored for a long time by the investigation area determination device 10. The storage device 640 may operate as a temporary storage device of the CPU 610. The storage device 640 is, for example, a hard disk device, a magneto-optical disk device, a solid state drive (SSD), or a disk array device.

The ROM 620 and the storage device 640 are non-transitory recording media. On the other hand, the RAM 630 is a transitory recording medium. The CPU 610 is operable based on a program stored in at least one of the ROM 620, the storage device 640, and the RAM 630. That is, the CPU 610 can operate using at least one of a nonvolatile recording medium and a volatile recording medium.

The NIC 650 relays exchange of data with an external device (not illustrated) via a network. The NIC 650 is, for example, a local area network (LAN) card. Furthermore, the NIC 650 is not limited to use wired communication, but may use wireless communication. The investigation area determination device 10 configured as described above can acquire an effect similar to that of the investigation area determination device 10 in FIG. 1. This is because the CPU 610 of the investigation area determination device 10 can implement a function similar to that of the investigation area determination device 10 in FIG. 1 based on the program.

### Second Example Embodiment

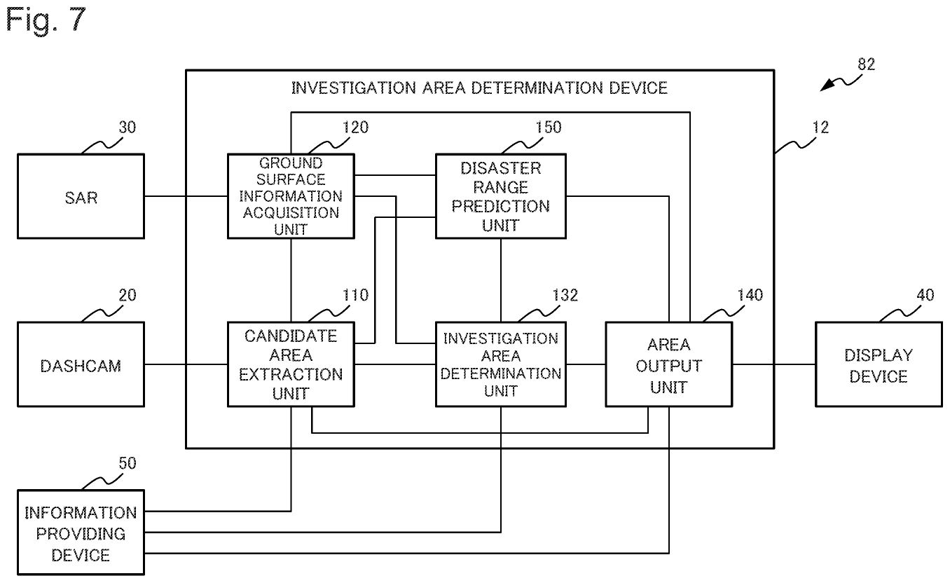

Next, the second example embodiment will be described with reference to the drawings. FIG. 7 is a block diagram illustrating an example of a configuration of an investigation area determination system 82 according to the second example embodiment. The investigation area determination system 82 includes the same configuration as the investigation area determination system 80 except that an investigation area determination device 12 is included instead of the investigation area determination device 10. Therefore, detailed description of configurations other than the investigation area determination device 12 will be omitted.

The investigation area determination device 12 includes an investigation area determination unit 132 instead of the investigation area determination unit 130, and further includes a disaster range prediction unit 150. The candidate area extraction unit 110 and the ground surface information acquisition unit 120 operate as in the first example embodiment. The investigation area determination unit 132 operates as in the investigation area determination unit 130 except that the prediction by the disaster range prediction unit 150 is used. Furthermore, the area output unit 140 operates as in the area output unit 140 of the first example embodiment except that the operation results of the investigation area determination unit 132 and the disaster range prediction unit 150 are output. Therefore, the description similar to that of the first example embodiment will be omitted as appropriate, and the disaster range prediction unit 150 will be mainly described below. The investigation area determination device 12 may be configured using the hardware illustrated in FIG. 6.

The disaster range prediction unit 150 predicts a disaster range in a predetermined time using the history of the change in the ground surface acquired by the ground surface information acquisition unit 120. The history is time series information. For example, in a case where a disaster is a flood, a range in which a change in the ground surface is larger than a threshold value can be generally regarded as a disaster range in many cases. The disaster range is, for example, a flood range. That is, a range in which the change in the ground surface is larger than a predetermined threshold value is often a disaster range. Therefore, the disaster range prediction unit 150 predicts a change in the ground surface at a predetermined time point using the history of the change in the ground surface, and predicts a disaster range at the time point using the predicted change in the ground surface. The configuration for storing the history of the change in the ground surface is any configurations. For example, the disaster range prediction unit 150 may store the change in the ground surface acquired by the ground surface information acquisition unit 120 as a history. Alternatively, a storage unit (not illustrated) may store a history of the change in the ground surface. Alternatively, an external device (not illustrated) may store a history of the change in the ground surface.

Further, the disaster range prediction unit 150 may predict the disaster range using the history of the sensor information acquired by the candidate area extraction unit 110 in addition to the history of the change in the ground surface or instead of the history of the change in the ground surface. The configuration for storing the history of the sensor information is any configurations. For example, the disaster range prediction unit 150 may store the sensor information acquired by the candidate area extraction unit 110 as a history. Alternatively, a storage unit (not illustrated) may store the history of the sensor information. Alternatively, an external device (not illustrated) may store the history of the sensor information.

The method used by the disaster range prediction unit 150 to predict the disaster range is not limited. For example, the disaster range prediction unit 150 may predict the disaster range by applying a predetermined statistical prediction method to at least one of the history of the change in the ground surface and the history of the sensor information. The statistical prediction method is, for example, an autoregressive model, a moving average method, or an exponential average method. Alternatively, the disaster range prediction unit 150 may use a prediction model generated using machine training with at least one of the past change in the ground surface and the sensor information as teacher data. Furthermore, the disaster range prediction unit 150 may predict at least one of the occurrence time of the secondary disaster and the range of the secondary disaster in addition to the disaster range based on at least one of the history of the change in the ground surface and the history of the sensor information.

The disaster range prediction unit 150 may predict the disaster range using the history of the type of the ground surface in addition to the history of the change in the ground surface. The type of the ground surface is, for example, a water surface. The disaster range is, for example, a flood range. Alternatively, the disaster range prediction unit 150 may predict the disaster range using the disaster information in addition to the history of the change in the ground surface. Alternatively, the disaster range prediction unit 150 may use information related to the land such as altitude, topography, and geology of each place in the prediction.

The disaster range prediction unit 150 may change the method used for predicting the disaster range according to the type of a disaster. The type of a disaster is, for example, a flood or an earthquake. For example, in the case of a flood, the disaster range is a range flooded by the flood. Therefore, the disaster range prediction unit 150 predicts the disaster range based on the history of the change in the ground surface (and the history of the type of the ground surface when available). For example, a disaster range is a flood range. On the other hand, regarding the damage on the road surface in the case of the earthquake, the progress of the disaster and the recovery are different in relation to not only the change in the ground surface but also the disaster-stricken state of the road surface in the earthquake. The disaster-stricken state of the road surface is, for example, a state of cracking and depressions. Therefore, in the case of an earthquake, the disaster range prediction unit 150 may predict the disaster range using the damage situation of the road surface predicted based on the history of the sensor information in addition to the prediction of the change in the ground surface determined based on the history of the change in the ground surface. The disaster range is, for example, a disaster range of a road.

The investigation area determination unit 132 determines the investigation area at the time of prediction using the predicted disaster range. More specifically, using the predicted disaster range at a predicted predetermined time point, the investigation area determination unit 132 determines the investigation area at that time point. The investigation area determination unit 132 may determine the investigation area using at least one of the predicted occurrence time of the secondary disaster and the range of the secondary disaster.

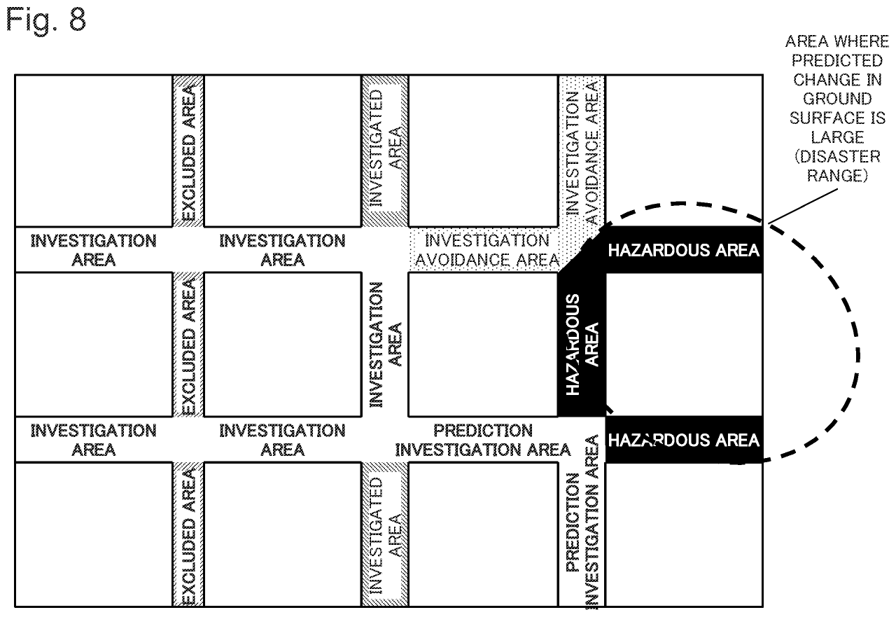

FIG. 8 is a diagram for describing an investigation area based on a prediction of a disaster range. FIG. 8 illustrates the disaster range predicted by the disaster range prediction unit 150 after a predetermined time from FIG. 4. After the predetermined time is, for example, 12 hours later. The disaster range is, for example, a range in which a change in the ground surface is large. As illustrated in FIG. 8, the disaster range prediction unit 150 predicts that the disaster range after the predetermined time is narrower than the range in FIG. 4. As a result, the lower section of the road in the up-down direction on the right side and the second section from the right of the road in the left-right direction on the lower side are out of the range where the change in the ground surface is large. As a result, the investigation area determination unit 132 determines the two sections as the investigation area. In FIG. 8, these two sections are referred to as “prediction investigation areas” for easy understanding.

In a case where the investigation area includes a road, the disaster range prediction unit 150 may predict the time for recovery of passage of the road using at least one of the history of the change in the ground surface and the history of the sensor information. For example, the disaster range prediction unit 150 predicts the possibility of the recovery status of the passage of the road based on the prediction of the change in the ground surface predicted using the history of the change in the ground surface and the state of the road predicted using the history of the sensor information. Then, the disaster range prediction unit 150 may set a time point at which the possibility of the prediction is higher than a predetermined value as the time for recovery. Further, the disaster range prediction unit 150 may acquire information related to a road recovery work such as a recovery plan by a local government from a predetermined device, and predict a time for recovery of the road using the acquired information related to the recovery work. The recovery plan is not particularly limited. For example, when the damage is a fallen tree, the recovery plan may be a tree fall removal plan. Alternatively, when the damage is a crack in the road, the recovery plan may be a road repair plan. Alternatively, when the damage is the depression of the road, the recovery plan may be a road repair plan.

The investigation area determination unit 132 may create an acquisition plan for the sensor information based on the predicted time for recovery of the road. For example, in a case where there is an area where recovery of the road is predicted in an area where the sensor information cannot be acquired because the road is closed at the current time, the investigation area determination unit 132 may create an acquisition plan of the sensor information using the predicted time for recovery. When the disaster range prediction unit 150 predicts the possibility of occurrence of a secondary disaster, the investigation area determination unit 130 may create an acquisition plan of sensor information in the investigation area using the prediction of the secondary disaster. For example, the investigation area determination unit 130 may create an acquisition plan in such a way as to avoid the secondary disaster. Furthermore, the investigation area determination unit 132 may create another plan using the predicted time for recovery of the road. The another plan is, for example, a distribution plan for predetermined supplies.

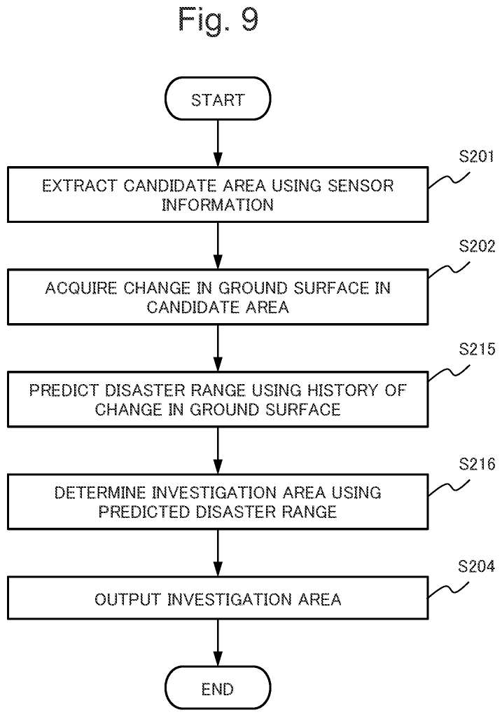

Next, an operation of the investigation area determination device 12 according to the second example embodiment will be described with reference to the drawings. FIG. 9 is a flowchart illustrating an example of the operation of the investigation area determination device 12 according to the second example embodiment. The candidate area extraction unit 110 extracts a candidate area for investigation of a disaster situation using the sensor information acquired by the dashcam 20 (step S201). The ground surface information acquisition unit 120 acquires a ground surface change that is a result of an analysis using the measurement result made by the SAR 30 in the candidate area (step S202). The disaster range prediction unit 150 predicts a disaster range at a predetermined time point using a history of the change in the ground surface (step S215). The investigation area determination unit 132 determines an investigation area at a predetermined time point using the predicted disaster range (step S216). Then, the area output unit 140 outputs the investigation area at the predetermined time point to a predetermined device (step S204). The predetermined device is, for example, the display device 40. As in the operation described with reference to FIG. 5, the investigation area determination unit 132 may determine the investigation area after step S202.

The investigation area determination device 12 according to the second example embodiment can provide an investigation area at a predetermined time point in addition to the effects of the first example embodiment. The reason is as follows. Unlike the investigation area determination device 10, the investigation area determination device 12 includes an investigation area determination unit 132 instead of the investigation area determination unit 130, and further includes the disaster range prediction unit 150. The disaster range prediction unit 150 predicts a disaster range at a predetermined time point in the future using a history of a ground surface change. The investigation area determination unit 132 determines an investigation area at a predetermined time point using the predicted disaster range. In this manner, the investigation area determination device 12 can predict the investigation area at the predetermined time point using the above configuration.

The disaster range prediction unit 150 may predict the disaster range using the history of the sensor information. In this case, the investigation area determination device 12 can make more accurate prediction using the history of the sensor information. The disaster range prediction unit 150 may predict the occurrence time of a secondary disaster. Further, the disaster range prediction unit 150 may predict the range of the secondary disaster. Secondary disasters affect disaster recovery. That is, the investigation area determination device 12 can provide information related to a secondary disaster in the future as information related to recovery from a disaster. The disaster range prediction unit 150 may predict a disaster range using disaster information. In this case, the investigation area determination device 12 can make more accurate prediction related to the disaster.

The disaster range prediction unit 150 may predict a time for recovery of passage of a road in the investigation area. Further, the investigation area determination unit 132 may create an acquisition plan of the sensor information using the time for recovery. In this case, the investigation area determination device 12 can create an acquisition plan of the sensor information in consideration of the predicted time for recovery of the road. The investigation area determination unit 132 may create a distribution plan for predetermined supplies using the time for recovery. In this case, the investigation area determination device 12 can create a distribution plan for supplies in consideration of the time for recovery.

The area output unit 140 may output the investigation area and the predicted disaster range. In this case, the investigation area determination device 12 can provide the user or the like with the predicted disaster range in addition to the investigation area. The area output unit 140 may output the investigation area and the acquisition plan. In this case, the investigation area determination device 12 can provide the user or the like with an acquisition plan in consideration of the predicted disaster range. The area output unit 140 may output the investigation area and the distribution plan. In this case, the investigation area determination device 12 can provide the user or the like with a distribution plan for predetermined supplies in consideration of the predicted disaster range.

### Third Example Embodiment

Instead of outputting the determined investigation area, the investigation area determination device 10 may store it in a storage unit (not illustrated) to output it in response to a request from the user or the like. Alternatively, the investigation area determination device 10 may include a display unit (not illustrated) to display the investigation area on the display unit. In these cases, the investigation area determination device 10 may not include the area output unit 140. Therefore, as the third example embodiment, the above case will be described.

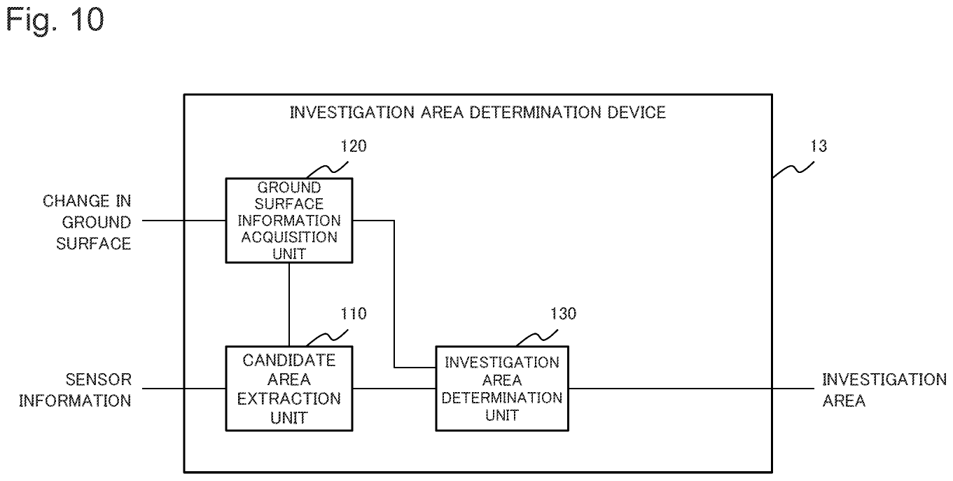

FIG. 10 is a block diagram illustrating an example of a configuration of an investigation area determination device 13 according to the third example embodiment. The investigation area determination device 13 includes the candidate area extraction unit 110, the ground surface information acquisition unit 120, and the investigation area determination unit 130. The candidate area extraction unit 110 extracts a candidate area for investigation of a disaster situation using the sensor information acquired by the sensor information acquisition device. The sensor information acquisition device is, for example, the dashcam 20. The ground surface information acquisition unit 120 acquires a ground surface change that is a result of an analysis using the measurement result made by the ground surface measurement device in the candidate area. The ground surface measurement device is, for example, the SAR 30. The investigation area determination unit 130 determines the investigation area for investigation of the disaster situation in the candidate area using the ground surface change. The investigation area determination device 13 may be configured using the hardware configuration illustrated in FIG. 6. As in the investigation area determination device 10, the investigation area determination device 13 configured as described above can determine an appropriate investigation area.

### Fourth Example Embodiment

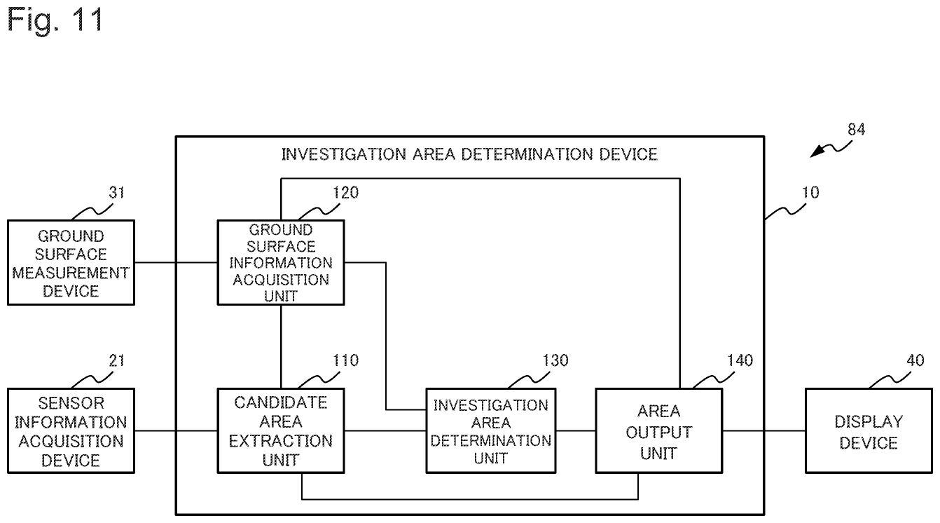

The investigation area determination system 80 may not include the information providing device 50. Therefore, an example of such a case will be described as the fourth example embodiment. FIG. 11 is a block diagram illustrating an example of a configuration of an investigation area determination system 84 according to the fourth example embodiment. The investigation area determination system 84 includes the investigation area determination device 10, a sensor information acquisition device 21, a ground surface measurement device 31, and the display device 40. The investigation area determination device 10 includes a candidate area extraction unit 110, a ground surface information acquisition unit 120, an investigation area determination unit 130, and an area output unit 140. The investigation area determination device 10 operates as in the investigation area determination device 10 of the first example embodiment except that information is not acquired from the information providing device 50. The investigation area determination device 10 according to the fourth example embodiment may be configured using a hardware configuration illustrated in FIG. 6. The sensor information acquisition device 21 outputs the sensor information to the investigation area determination device 10. The ground surface measurement device 31 outputs a measurement result to the investigation area determination device 10. The display device 40 acquires the investigation area from the investigation area determination device 10 to display it.

In the investigation area determination system 84 configured as described above, the investigation area determination device 10 operates as described above. That is, the investigation area determination device 10 extracts a candidate area for investigation of the disaster situation using the sensor information acquired by the sensor information acquisition device 21. The sensor information acquisition device 21 is, for example, a dashcam 20. Then, the investigation area determination device 10 acquires a ground surface change that is a result of an analysis using the measurement result made by the ground surface measurement device 31 in the candidate area. The ground surface measurement device 31 is, for example, the SAR 30. Then, the investigation area determination device 10 determines the investigation area of the disaster situation in the candidate area using the ground surface change. Then, the investigation area determination device 10 outputs the investigation area. Then, the display device 40 displays the investigation area. The investigation area determination system 84 configured as described above can acquire an effect similar to that of the investigation area determination system 80.

Some or all of the above example embodiments may be described as the following Supplementary Notes, but are not limited to the following.

### (Supplementary Note 1)

An investigation area determination device including

a candidate area extraction means configured to extract a candidate area for investigation of a disaster situation using sensor information acquired by a sensor information acquisition device,

a ground surface information acquisition means configured to acquire a ground surface change that is a result of an analysis using a measurement result made by a ground surface measurement device in the candidate area, and

an investigation area determination means configured to determine an investigation area for investigation of a disaster situation in the candidate area using the ground surface change.

### (Supplementary Note 2)

The investigation area determination device according to Supplementary Note 1, wherein

the candidate area includes a non-acquisition area where the sensor information used for extraction of the candidate area is not acquired.

### (Supplementary Note 3)

The investigation area determination device according to Supplementary Note 2, wherein

the candidate area includes an area where the sensor information cannot be acquired in the non-acquisition area.

### (Supplementary Note 4)

The investigation area determination device according to any one of Supplementary Notes 1 to 3, wherein

the candidate area is an area where a mobile body on which the sensor information acquisition device is mounted is movable.

### (Supplementary Note 5)

The investigation area determination device according to Supplementary Note 4, wherein

the mobile body on which the sensor information acquisition device is mounted is a vehicle.

### (Supplementary Note 6)

The investigation area determination device according to any one of Supplementary Notes 1 to 5, wherein

the sensor information includes at least one of an image, a speed, acceleration, and a distance.

### (Supplementary Note 7)

The investigation area determination device according to any one of Supplementary Notes 1 to 6, wherein

the candidate area extraction means extracts the candidate area using disaster information.

### (Supplementary Note 8)

The investigation area determination device according to Supplementary Note 7, wherein

the disaster information includes at least one of a rainfall range, an amount of rainfall, rain cloud information, a wind direction, a wind volume, a seismic source, seismic intensity, a situation of an aftershock, a power outage, a water outage, a map related to a disaster, a disaster range, a secondary disaster, and past disaster information.

### (Supplementary Note 9)

The investigation area determination device according to any one of Supplementary Notes 1 to 8, wherein

the investigation area determination means determines an investigatable area using the ground surface change, and determines the investigation area based on the investigatable area and the candidate area.

### (Supplementary Note 10)

The investigation area determination device according to any one of Supplementary Notes 1 to 9, wherein

the investigation area determination means sets an investigation priority in the investigation area using at least one of the ground surface change and the sensor information.

(Supplementary Note 11) The investigation area determination device according to any one of Supplementary Notes 1 to 10, wherein

the investigation area determination means determines the investigation area using a type of a ground surface.

### (Supplementary Note 12)

The investigation area determination device according to any one of Supplementary Notes 1 to 11, wherein

the investigation area determination means determines a hazardous area that is an area where it is better to avoid investigation, using at least one of the ground surface change and the sensor information.

### (Supplementary Note 13)

The investigation area determination device according to Supplementary Note 12, wherein

the hazardous area is at least one of an area where the ground surface change is larger than a predetermined value and an area where the sensor information includes information related to danger.

### (Supplementary Note 14)

The investigation area determination device according to Supplementary Note 12 or 13, wherein

the investigation area determination means determines a risk level of the hazardous area using at least one of the ground surface change and the sensor information.

### (Supplementary Note 15)

The investigation area determination device according to any one of Supplementary Notes 12 to 14, wherein the investigation area determination means determines the hazardous area using a type of a ground surface.

### (Supplementary Note 16)

The investigation area determination device according to any one of Supplementary Notes 1 to 15, wherein

the investigation area determination means determines a type of a disaster using at least one of the sensor information and the ground surface change.

### (Supplementary Note 17)

The investigation area determination device according to any one of Supplementary Notes 1 to 16, wherein

the investigation area determination means determines a disaster range using at least one of the sensor information and the ground surface change acquired in the investigation area.

### (Supplementary Note 18)

The investigation area determination device according to any one of Supplementary Notes 1 to 17, further including

a disaster range prediction means configured to predict a disaster range at a future predetermined time point using a history of the ground surface change, wherein

the investigation area determination means determines the investigation area at the predetermined time point using the predicted disaster range.

### (Supplementary Note 19)

The investigation area determination device according to Supplementary Note 18, wherein

the disaster range prediction means predicts the disaster range using a history of the sensor information.

### (Supplementary Note 20)

The investigation area determination device according to Supplementary Note 18 or 19, wherein

the disaster range prediction means predicts an occurrence time of a secondary disaster.

### (Supplementary Note 21)

The investigation area determination device according to any one of Supplementary Notes 18 to 20, wherein

the disaster range prediction means predicts a range of a secondary disaster.

### (Supplementary Note 22)

The investigation area determination device according to any one of Supplementary Notes 18 to 21, wherein

the disaster range prediction means predicts the disaster range using disaster information.

### (Supplementary Note 23)

The investigation area determination device according to any one of Supplementary Notes 18 to 22, wherein

the disaster range prediction means predicts a time for recovery of passage of a road, and

the investigation area determination means creates an acquisition plan of the sensor information using the time for recovery.

### (Supplementary Note 24)

The investigation area determination device according to Supplementary Note 23, wherein

the investigation area determination means creates a distribution plan for predetermined supplies using the time for recovery.

### (Supplementary Note 25)

The investigation area determination device according to any one of Supplementary Notes 1 to 24, further including

an area output means configured to output the investigation area.

### (Supplementary Note 26)

The investigation area determination device according to any one of Supplementary Notes 12 to 15, further including

an area output means configured to output the investigation area and the hazardous area.

### (Supplementary Note 27)

The investigation area determination device according to Supplementary Note 10, further including

an area output means configured to output the investigation area and the investigation priority of the investigation area.

### (Supplementary Note 28)

The investigation area determination device according to Supplementary Note 2, further including

an area output means configured to output the investigation area and the non-acquisition area.

### (Supplementary Note 29)

The investigation area determination device according to any one of Supplementary Notes 25 to 28, wherein

the area output means outputs the sensor information in the investigation area.

### (Supplementary Note 30)

The investigation area determination device according to any one of Supplementary Notes 25 to 29, wherein

the area output means outputs the ground surface change in the investigation area.

### (Supplementary Note 31)

The investigation area determination device according to any one of Supplementary Notes 25 to 30, wherein

the area output means outputs the candidate area.

### (Supplementary Note 32)

The investigation area determination device according to any one of Supplementary Notes 25 to 31, wherein

the area output means outputs a measurement time of the measurement result used to analyze the ground surface change used to determine the investigation area.

### (Supplementary Note 33)

The investigation area determination device according to any one of Supplementary Notes 25 to 32, wherein

the area output means outputs disaster information related to the investigation area.

### (Supplementary Note 34)

The investigation area determination device according to any one of Supplementary Notes 18 to 24, further including

an area output means configured to output the investigation area and the predicted disaster range.

### (Supplementary Note 35)

The investigation area determination device according to Supplementary Note 23, further including

an area output means configured to output the investigation area, the predicted disaster range, and the acquisition plan.

### (Supplementary Note 36)

The investigation area determination device according to Supplementary Note 24, further including

an area output means configured to output the investigation area, the predicted disaster range, and the distribution plan.

### (Supplementary Note 37)

An investigation area determination system including

the investigation area determination device according to any one of Supplementary Notes 1 to 36,

the sensor information acquisition device that outputs the sensor information to the investigation area determination device,

the ground surface measurement device that outputs the measurement result to the investigation area determination device, and

a display device that acquires the investigation area from the investigation area determination device and displays the investigation area.

### (Supplementary Note 38)

An investigation area determination method including

extracting a candidate area for investigation of a disaster situation using sensor information acquired by a sensor information acquisition device,

acquiring a ground surface change that is a result of an analysis using a measurement result made by a ground surface measurement device in the candidate area, and

determining an investigation area for investigation of a disaster situation in the candidate area using the ground surface change.

### (Supplementary Note 39)

An investigation area determination method including

an investigation area determination device executing the method according to Supplementary Note 38,

the sensor information acquisition device outputting the sensor information to the investigation area determination device,

the ground surface measurement device outputting the measurement result to the investigation area determination device, and

a display device acquiring the investigation area from the investigation area determination device and displaying the investigation area.

### (Supplementary Note 40)

A recording medium that records a program for causing a computer to execute the steps of

extracting a candidate area for investigation of a disaster situation using sensor information acquired by a sensor information acquisition device,

acquiring a ground surface change that is a result of an analysis using a measurement result made by a ground surface measurement device in the candidate area, and

determining an investigation area for investigation of a disaster situation in the candidate area using the ground surface change.

Although the present invention is described above with reference to the example embodiments, the present invention is not limited to the above example embodiments. It will be understood by those of ordinary skill in the art that various changes in form and details may be made therein without departing from the spirit and scope of the present invention as defined by the claims.

### REFERENCE SIGNS LIST

10 investigation area determination device
12 investigation area determination device
13 investigation area determination device
20 dashcam
21 sensor information acquisition device
30 SAR
31 ground surface measurement device
40 display device
50 information providing device
80 investigation area determination system
82 investigation area determination system
84 investigation area determination system
110 candidate area extraction unit
120 ground surface information acquisition unit
130 investigation area determination unit
132 investigation area determination unit
140 area output unit
150 disaster range prediction unit
610 CPU
620 ROM
630 RAM
640 storage device
650 NIC
810 computer
820 dashcam
830 SAR system
840 terminal device
850 vehicle
880 network

What is claimed is:

1. An investigation area determination device comprising:
a memory configured to store instructions; and
one or more processors configured to execute the instructions to:
extract a candidate area for investigation of a disaster situation using sensor information acquired by a sensor information acquisition device;
acquire a ground surface change that is a result of an analysis using a measurement result made by a ground surface measurement device in the candidate area; and
determine an investigation area for investigation of a disaster situation in the candidate area using the ground surface change.

2. The investigation area determination device according to claim 1, wherein
the candidate area includes a non-acquisition area where the sensor information used for extraction of the candidate area is not acquired.

3. The investigation area determination device according to claim 2, wherein
the candidate area includes an area where the sensor information cannot be acquired in the non-acquisition area.

4. The investigation area determination device according to claim 1, wherein
the candidate area is an area where a mobile body on which the sensor information acquisition device is mounted is movable.

5. The investigation area determination device according to claim 4, wherein
the mobile body on which the sensor information acquisition device is mounted is a vehicle.

6. The investigation area determination device according to claim 1, wherein
the sensor information includes at least one of an image, a speed, acceleration, and a distance.

7. The investigation area determination device according to claim 1, wherein
the ground surface measurement device includes a synthetic aperture radar.

8. The investigation area determination device according to claim 1, wherein
the one or more processors are further configured to execute the instructions to:
extract the candidate area using disaster information.

9. The investigation area determination device according to claim 8, wherein
the disaster information includes at least one of a rainfall range, an amount of rainfall, rain cloud information, a wind direction, a wind volume, a seismic source, seismic intensity, a situation of an aftershock, a power outage, a water outage, a map related to a disaster, a disaster range, a secondary disaster, and past disaster information.

10. The investigation area determination device according to claim 1, wherein
the one or more processors are further configured to execute the instructions to:
determine an investigatable area using the ground surface change, and determine the investigation area based on the investigatable area and the candidate area.

11. The investigation area determination device according to claim 1, wherein
the one or more processors are further configured to execute the instructions to:
set an investigation priority in the investigation area using at least one of the ground surface change and the sensor information.

12. The investigation area determination device according to claim 1, wherein
the one or more processors are further configured to execute the instructions to:
determine the investigation area using a type of a ground surface.

13. The investigation area determination device according to claim 1, wherein
the one or more processors are further configured to execute the instructions to:
determine a hazardous area that is an area where it is better to avoid investigation, using at least one of the ground surface change and the sensor information.

14. The investigation area determination device according to claim 13, wherein
the hazardous area is at least one of an area where the ground surface change is larger than a predetermined value and an area where the sensor information includes information related to danger.

15. The investigation area determination device according to claim 13, wherein
the one or more processors are further configured to execute the instructions to:
determine a risk level of the hazardous area using at least one of the ground surface change and the sensor information.

16. The investigation area determination device according to claim 13, wherein
the one or more processors are further configured to execute the instructions to:
determine the hazardous area using a type of a ground surface.

17. The investigation area determination device according to claim 1, wherein
the one or more processors are further configured to execute the instructions to:
determine a type of a disaster using at least one of the sensor information and the ground surface change.

18. The investigation area determination device according to claim 1, wherein
the one or more processors are further configured to execute the instructions to:
determine a disaster range using at least one of the sensor information and the ground surface change acquired in the investigation area.

19-38. (canceled)

39. An investigation area determination method comprising:
extracting a candidate area for investigation of a disaster situation using sensor information acquired by a sensor information acquisition device;
acquiring a ground surface change that is a result of an analysis using a measurement result made by a ground surface measurement device in the candidate area; and
determining an investigation area for investigation of a disaster situation in the candidate area using the ground surface change.

40. (canceled)

41. A non-transitory computer-readable recording medium that records a program for causing a computer to execute:
extracting a candidate area for investigation of a disaster situation using sensor information acquired by a sensor information acquisition device;
acquiring a ground surface change that is a result of an analysis using a measurement result made by a ground surface measurement device in the candidate area; and
determining an investigation area for investigation of a disaster situation in the candidate area using the ground surface change.
